(19) United States
(12) Patent Application Publication
(10) Pub. No.: US 2025/0375995 A1
(43) Pub. Date: Dec. 11, 2025

(54) DISTRIBUTION DUCTS FOR HVAC SYSTEM

(71) Applicant: MAHLE INTERNATIONAL GMBH, Stuttgart (DE)

(72) Inventors: Jeffrey KINMARTIN, East Amherst, NY (US); Ryan PHILIPPS, Kenmore, NY (US); Randy Lawrence WILER, Kendall, NY (US); Austin MACEY, West Seneca, NY (US)

(21) Appl. No.: 18/933,447

(22) Filed: Oct. 31, 2024

Related U.S. Application Data
(60) Provisional application No. 63/656,224, filed on Jun. 5, 2024.

(51) Int. Cl. B60H 1/00

(52) U.S. Cl. CPC B60H 1/00021; B60H 1/00514; B60H 1/00564; B60H 1/00842; B60H 2001/00092

(57) ABSTRACT

An HVAC system that optimized for minimizing the amount of electrical power used during operation at various levels producing cold air or warm air is provided. The system includes an air inlet, a scroll, an air conditioning module, and an air delivery system for various locations within a vehicle that includes the HVAC system.

### CROSS-REFERENCE TO RELATED APPLICATIONS

This application claims priority from U.S. Provisional Application No. 63/656,224, filed Jun. 5, 2024, the entirety of which is hereby incorporated by reference herein.

### BACKGROUND

This application relates to HVAC systems for passenger vehicles, such as vehicles with conditioned air flow paths to second and third rows of a passenger vehicle.

### BRIEF SUMMARY

A first representative embodiment of the disclosure is provided. The embodiment is an HVAC system for a vehicle. The system includes an air intake housing that includes an air inlet and an air outlet, the air inlet comprising a first inlet that is aligned to receive air flowing from a passenger compartment of a vehicle that includes the housing, and a second inlet that is configured to receive air from outside of a vehicle. The air outlet receives air from the first and second inlets and allows the air from the first and second inlets to flow to a fan housing that is connected to an air outlet of the air intake housing. The housing includes a valve disposed within the housing that is positionable in a first position to allow air flow from the first air inlet to the air outlet and prevent flow from the second inlet to reach the air outlet, is positionable in a second position that allows air flow from the second inlet to flow to the air outlet and prevents air flow from the first air inlet to reach the air outlet. The air intake housing includes a first space for receiving a filter, wherein when the filter is installed within the first space, the air that is allowed by the valve to flow to the air outlet flows through the filter before reaching the air outlet, wherein the housing further comprises a second space disposed between the first space and the air outlet, such that air that flows through the filter when installed flows through the second space before reaching the air outlet.

Another representative embodiment of the disclosure is provided. The embodiment is an HVAC system for a vehicle. The system includes an air inlet housing that supports a fan housing, and a fan that is rotatably mounted within the fan housing, wherein air from the air inlet housing flows directly to a suction of the fan, and when the fan is rotating about its rotational axis air is expelled out of the fan radially away from the rotational axis. The system additionally includes a scroll that receives the expelled air from the fan when the fan rotates within the fan housing, wherein the scroll transitions from the fan housing to a pathway that leads to an air conditioning housing, the air conditioning housing includes an evaporator of a heat pump or refrigeration system associated with a vehicle, the scroll extends around the fan to direct air expelled from the fan to an exit of the scroll that transitions to an inlet into the pathway. The pathway includes the inlet and transitions to an outlet that is proximate to an evaporator within an air conditioning housing, wherein a cross-sectional area of the pathway increases as the pathway extends from the inlet to the outlet.

Another representative embodiment of the disclosure is provided. The embodiment is an HVAC system for a vehicle. The system includes a ventilation housing comprising an air inlet that is configured to receive air from a discharge of a ventilation fan, the housing comprises an evaporator and a heater that are each within a heat pump system, the ventilation housing further comprises a plurality of doors therewith that are controllable by an HVAC controller to direct air within and out of the ventilation housing, the housing further comprising a panel outlet, a rear outlet, and a front floor outlet. The air inlet directs the received air to the evaporator, the heater is positioned such that air that leaves the evaporator can flow through the heater or can bypass the heater depending upon the position of a first door. The first door is positionable in a first position that allows air leaving the evaporator to flow to the heater and prevents air from flowing directly to a rear outlet, and a second position that prevents air leaving the evaporator to flow to the heater and allows to flow into a first plenum and toward the rear outlet. The plurality of doors further include a second door positioned downstream of the heater, wherein when the second door is in a first position air leaving the heater is allowed to flow through a second plenum and toward the rear outlet, and when the second door is in a second position, air leaving the heater is prevented from flowing into the second plenum and toward the rear outlet. The first and second plenums have substantially the same cross-sectional at smallest portion of each respective plenum, and wherein the first and second plenums each have substantially the same cross-sectional area at their smallest portion as a cross-sectional area of the rear outlet of the ventilation housing.

Another representative embodiment of the disclosure is provided. The embodiment is an HVAC system for a vehicle. The system includes a distribution housing for receiving conditioned air, the distribution housing including an inlet and a plurality of outlets, the plurality of outlets comprise a first outlet for a second row floor vent, a second outlet for a second row console vent, and a third outlet for a third row vent. The distribution housing further comprising an inlet section through which all air flowing through the inlet flows, and upper and lower sections that extend from the inlet section, wherein the upper section is vertically above the lower section when the distribution housing is installed within a vehicle, wherein air that flows toward one of the first or second outlets flows into the upper section and air that flows through the third outlet flows into the lower section. The system further includes a first door in the upper section, wherein when the first door is in a first position air flows to the first outlet and is prevented from flowing to the second outlet, and when the first door is in a second position, air is prevented from flowing to the first outlet and air is allowed to flow toward the second outlet, wherein the first door can be positioned in an intermediate position that allows air to flow to the first outlet and to flow toward the second outlet.

Another representative embodiment of the disclosure is provided. The embodiment is a flow selector mechanism for an HVAC system for a vehicle. The flow selector mechanism includes a housing that includes an air inlet and first and second outlets, the air inlet configured to receive conditioned air flowing therein. A rotatable valve is disposed within the housing, the valve can be in positions to block the air inlet, block the first outlet, block the second outlet, and in a position to allow to flow from the air inlet and to the first and second outlets simultaneously. The housing includes a circular body, the valve rotates about an axis that is the same as the center of the circular body, wherein the valve includes a pivot that extends through or close to the center of the circular body, an outer curved surface, and a radial rib that connects the outer curved surface to the pivot. The air inlet extends radially from the circular body, and the first outlet and the second outlet each extending from the circular body on opposite sides of a line that extends through the center of the circular body and a centerline through the air inlet.

Another representative embodiment includes the structure in one or more of the representative embodiments described above in combination.

Additional representative embodiments are provided and include representative embodiments that in the structure described in one or more of Representative Paragraphs 1-77 provided at the end of the specification of this application.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a rear perspective view of an air intake housing for use with an HVAC system of FIG. 40.

FIG. 2 is a bottom perspective view of the air intake housing of FIG. 1.

FIG. 3 is a rear view (from the direction of within the passenger compartment when the air intake housing is installed within a vehicle) of the air intake housing of FIG. 1.

FIG. 4 is a bottom view of the air intake housing of FIG. 1.

FIG. 5 is a perspective cross-sectional view of section AA-AA of the air intake housing of FIG. 1, with the air filter not installed.

FIG. 6 is another perspective cross-sectional view of section AA-AA of the air intake housing of FIG. 1, with the air filter installed.

FIG. 7 is a front perspective view of the HVAC system including a fan housing, fan scroll, pathway, and an air conditioning housing.

FIG. 8 is a front side view of the HVAC system of FIG. 7.

FIG. 8a is a side view of the pathway and air conditioning housing schematically depicting the air flow within the pathway.

FIG. 9 is top cross-sectional view of section LL-LL of the HVAC system of FIG. 7.

FIG. 9a is a perspective view of the fan for use within the fan housing of the HVAC system.

FIG. 10 is a front perspective cross-sectional view of section MM-MM of the HVAC system of FIG. 7.

FIG. 11 is a front perspective cross-sectional view of section NN-NN of the HVAC system of FIG. 7.

FIG. 12 is a perspective view of an air mixing damper system, with doors to isolate the hot and cold air flows aligned in a planar manner with each other, to allow hot air to pass thereby but block flow of cold air from flowing thereby.

FIG. 13 is an exploded view of an air circulation assembly for a vehicle, with two air mixing damper systems, one to control air flow toward a driver's side seat area of the interior of a vehicle (left side on the figure) and a second to control air flow toward a passenger's side seat area of the interior of a vehicle (right side of the figure).

FIG. 14 is a perspective view the air mixing damper system of FIG. 12 with the doors aligned to allow both the hot and cold air flows to pass thereby.

FIG. 15 is another perspective view of the air mixing damper system with the doors aligned as in FIG. 13.

FIG. 16 is yet another perspective view of the air mixing damper system with the doors aligned as in FIG. 13.

FIG. 17 is a detail view of the outside of the housing of an air circulation assembly that includes the air mixing damper system of FIG. 12 with the actuators removed.

FIG. 18 is an exploded view of the second shaft and the first and second doors.

FIG. 18a is a detail view of detail Z of FIG. 18.

FIG. 18b is a detail view of detail Y of FIG. 18.

FIG. 19 is a side view of the housing of the air circulation assembly depicting the first and second doors in closed positions preventing flow from the respective hot air and cold air sources to flow into the mixing space, and depicting doors that control flow to the defrost system (494a, 494), the de-mist system (495a, 495), the vent panel (494a, 494), the floor ventilation system (497, 497a), a cold air flow to an extended air flow system (e.g. controls for air flow for a second or third row of a vehicle (cold air—498a, 402b, 498, and hot air 498b, 403b, 498), the valves for the associated systems that receive air from the mixing space (and directly from the cold air and warm air sources to send to the extended air flow system) are depicted in arbitrary closed positions by they can also be in the open position opposite positions to allow air flow therepast).

FIG. 19a is another side view of the housing.

FIG. 19b is a cross-sectional view of section II-II (eye, eye) of FIG. 19a.

FIG. 19c is a cross-sectional view of section JJ-JJ of FIG. 19a.

FIG. 20 is the view of FIG. 19 with the first and second doors in the open positions to allow flow form the respective hot and cold air sources into the mixing space.

FIG. 21 is the view of FIG. 19 with the first door in the closed position to prevent hot air from flowing into the mixing space and the second door in the open position to allow cold air to flow into the mixing space.

FIG. 22 is the view of FIG. 19 with the first door in the open position to allow hot air to flow into the mixing space and the second door in the closed position to prevent cold air from flowing into the mixing space.

FIG. 23 is a perspective view of the housing in the configuration of FIG. 21.

FIG. 24 is the view of FIG. 19 with the first and second doors each in the partially open partially closed (throttled open) position to allow some flow from the respective hot and cold air sources to flow into the mixing space but to not allow full flow as when the respective doors are fully open.

FIG. 25a is a view of the outside of the housing that depicts the various actuators that are provided to operate the air mixing damper system that controls air flow to the driver's side seat area of the interior of a vehicle.

FIG. 25b is a view of the outside of the housing that depicts the various actuators that are provided to operate the air mixing damper system that controls air flow to the passenger's side seat area of the interior of a vehicle.

FIG. 26 is a front driver side perspective view of a distributor duct of the HVAC system that is configured to receive air from the rear outlet of the air conditioning housing.

FIG. 27 is a rear driver side perspective view of the distributor duct of FIG. 26.

FIG. 28 a front passenger side perspective view of the distributor duct of FIG. 26.

FIG. 29 is a front driver side cross-sectional perspective view of section BB-BB of FIG. 26, depicting the valves aligned for air flow to a center console in a second row of the vehicle that includes the HVAC system (in this instance driver side, passenger side would be the same valve orientation as depicted in this figure but in the view of FIG. 31 introduced below).

FIG. 30 is the view of FIG. 29 with the valves aligned for air flow to the vents in a second row pillar of the vehicle that includes the HVAC system (in this instance driver side, passenger side would be the same valve orientation as depicted in this figure but in the view of FIG. 31).

FIG. 31 is a front driver side cross-sectional perspective view of section CC-CC of FIG. 26, depicting the valves aligned for air flow to floor vents within the second row of the passenger vehicle (in this instance, passenger side, driver side would be the same valve orientation as depicted in this figure but in the view of FIGS. 29 and 30).

FIG. 32 is a front perspective view of an air flow selection system that is usable with the HVAC system.

FIG. 33 is rear perspective view of the air flow selection system of FIG. 32.

FIG. 34 is a top view of the air flow selection system of FIG. 32.

FIG. 35 is a perspective view of the air flow selection system of FIG. 32 with the top housing removed, with the valve blocking flow out of the first air outlet aperture.

FIG. 36 is a rear perspective view of the air flow selection system in the orientation of FIG. 35, with the valve blocking air flow out of the first air outlet aperture.

FIG. 37 is a front perspective view of the air flow selection system in the orientation of FIG. 35, with the valve blocking air flow out of the first air outlet aperture.

FIG. 38 is a perspective view of the valve of the air flow selection system of FIG. 32.

FIG. 39A is a top view of the air flow selection system of FIG. 32, with the valve visible, and depicting the valve in a rest position that does not block either the air inlet our either air outlets.

FIG. 39B is the view of FIG. 39A, with the valve visible, and depicting the valve blocking the first air outlet.

FIG. 39C is the view of FIG. 39A, with the valve visible, and depicting the valve blocking the second air outlet.

FIG. 39D is the view of FIG. 39A, with the valve visible, and depicting the valve in a second rest position that does not block either the air inlet or either air outlets.

FIG. F 39E is the view of FIG. 39A, with the valve visible, and depicting the valve blocking the air inlet.

FIG. 40 is a rear perspective view of the HVAC system for use in a passenger vehicle with three rows, with the dashboard of the vehicle removed.

FIG. 41 is the view of FIG. 41 depicting a portion of the vehicle's dashboard.

FIG. 42 is a driver side rear perspective view of the air intake housing, the fan housing, and the air conditioning housing of the HVAC system of FIG. 40.

FIG. 43 is a driver side front perspective view of the air intake housing, the fan housing and scroll, the pathway, and the air conditioning housing of the HVAC system of FIG. 40.

### DETAILED DESCRIPTION

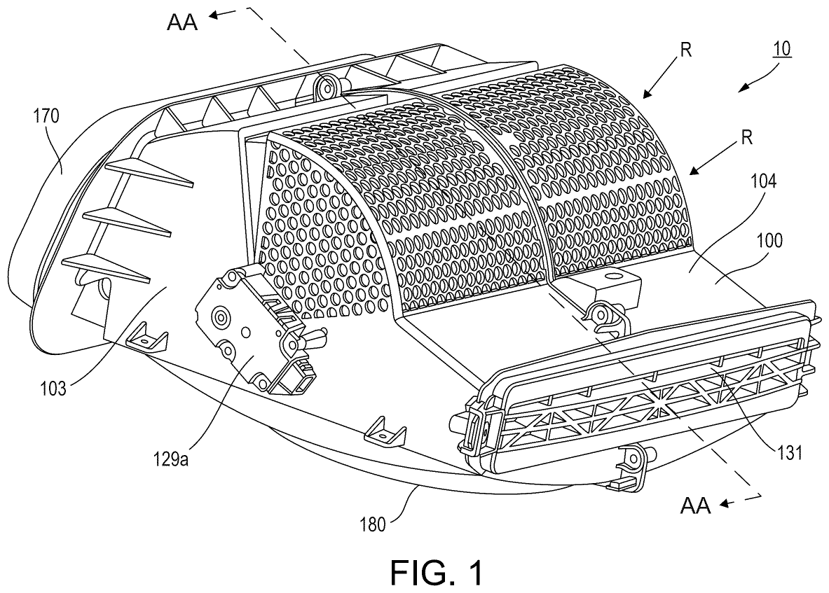

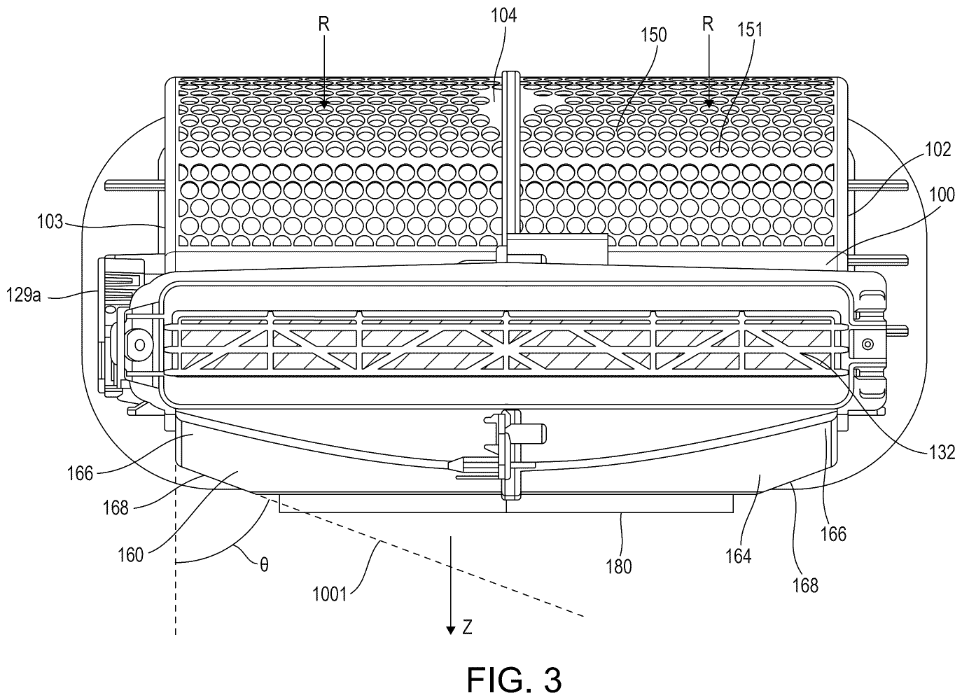

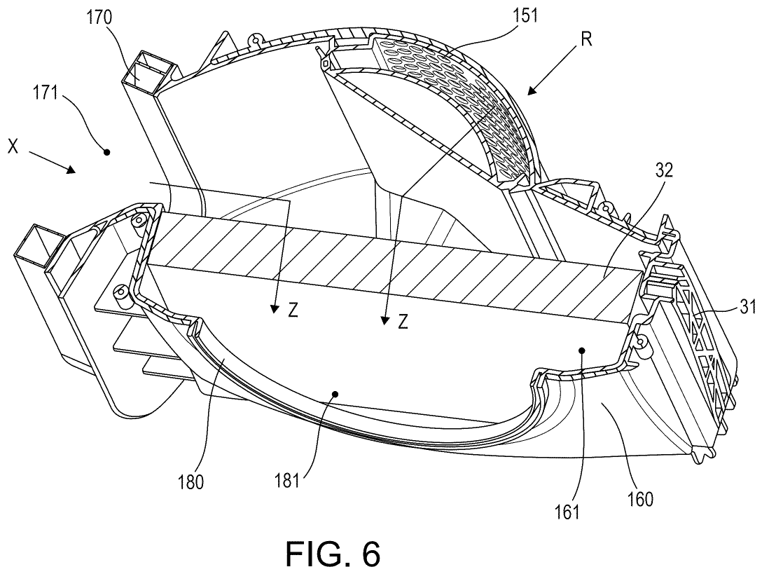

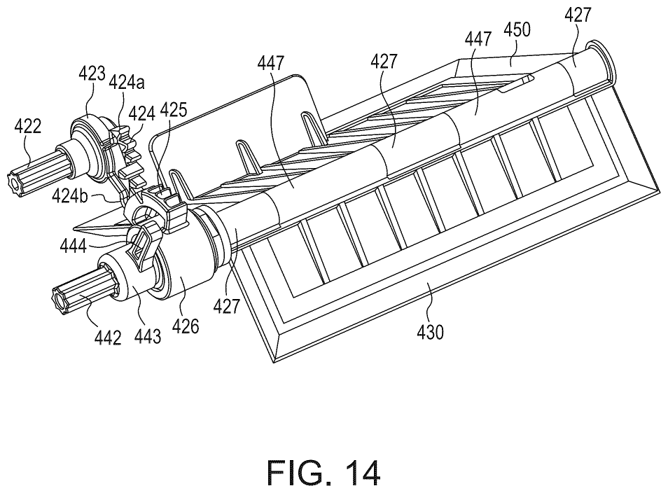

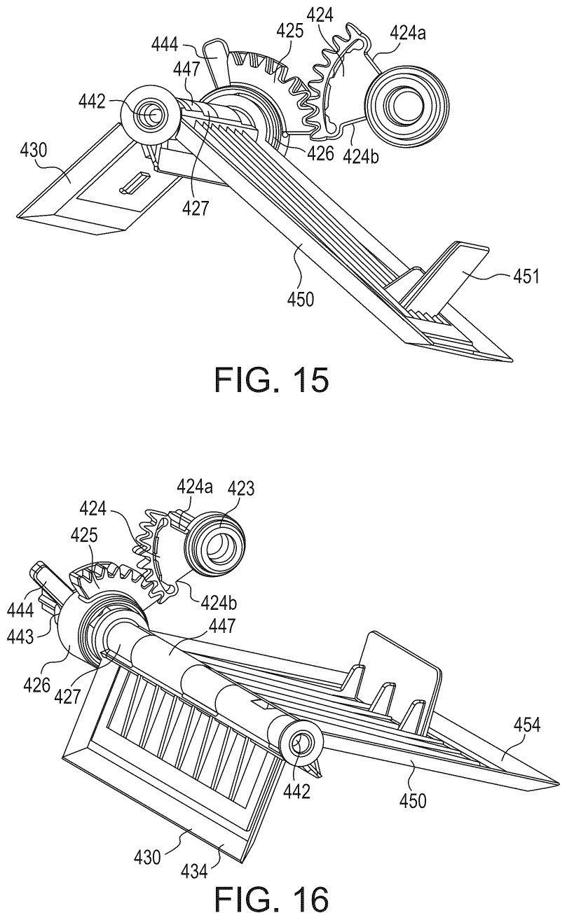

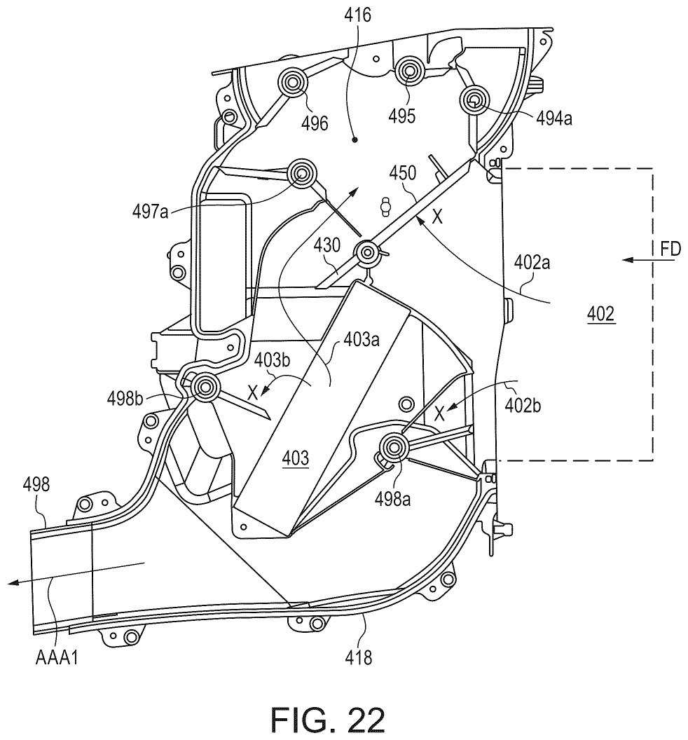

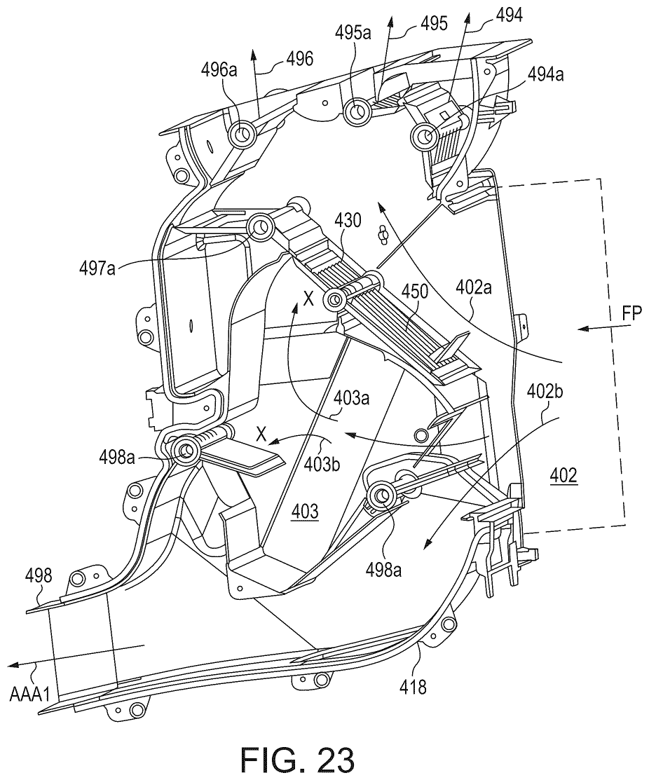

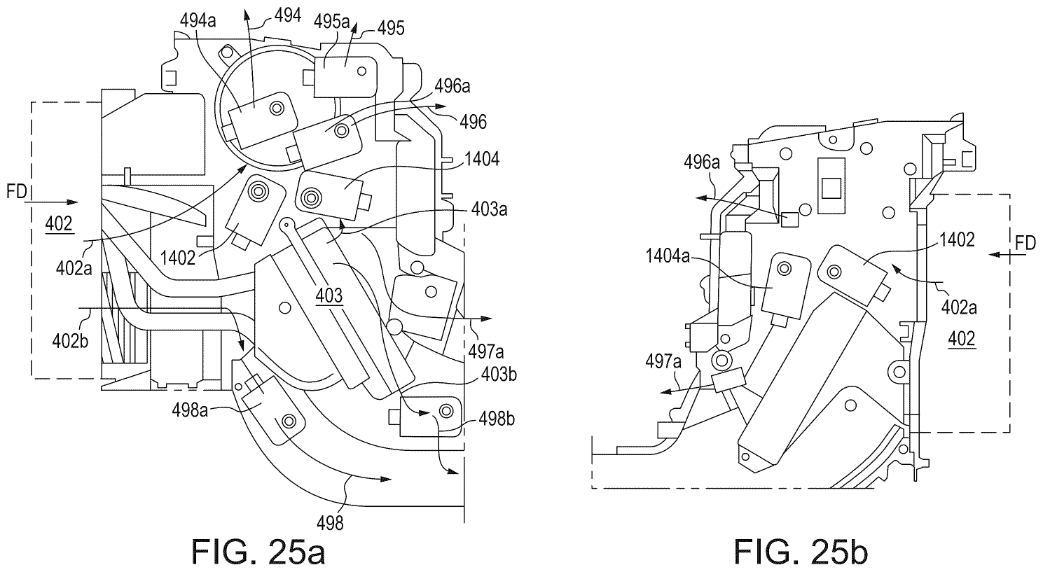

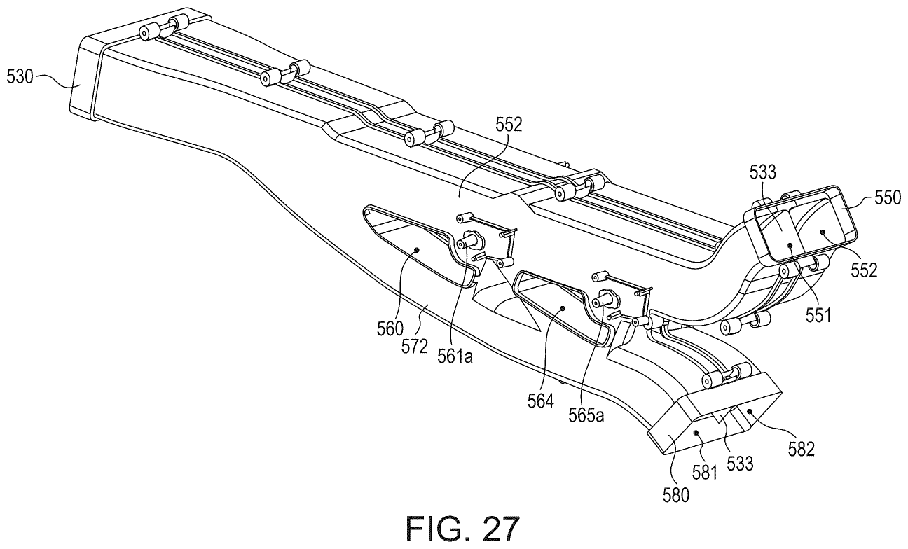

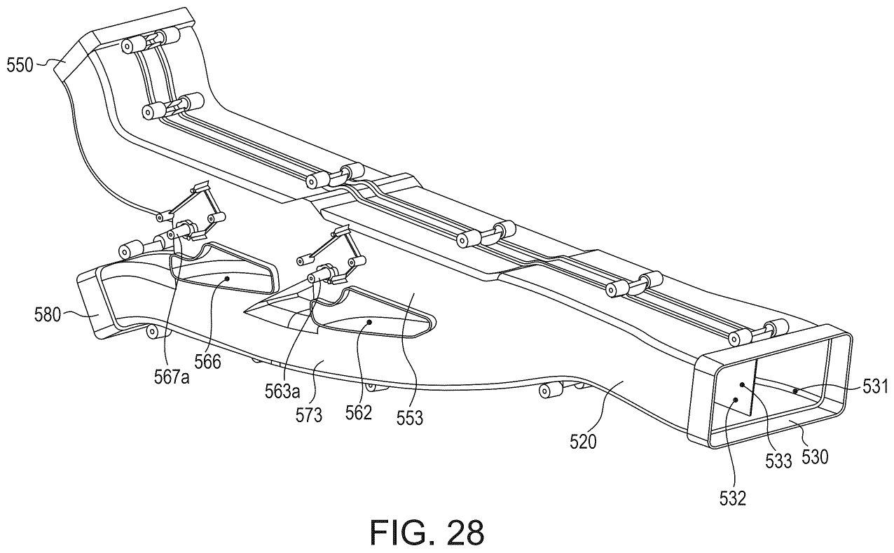

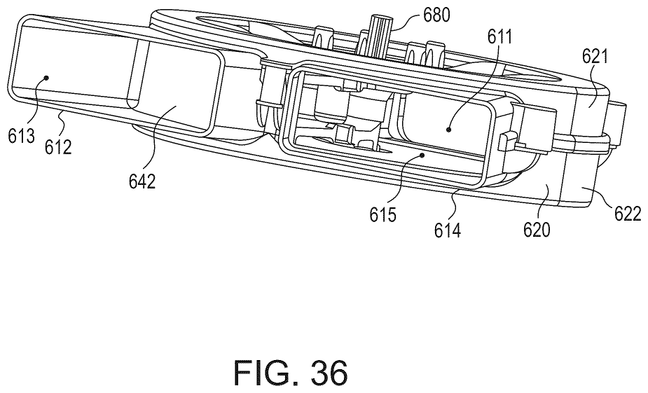

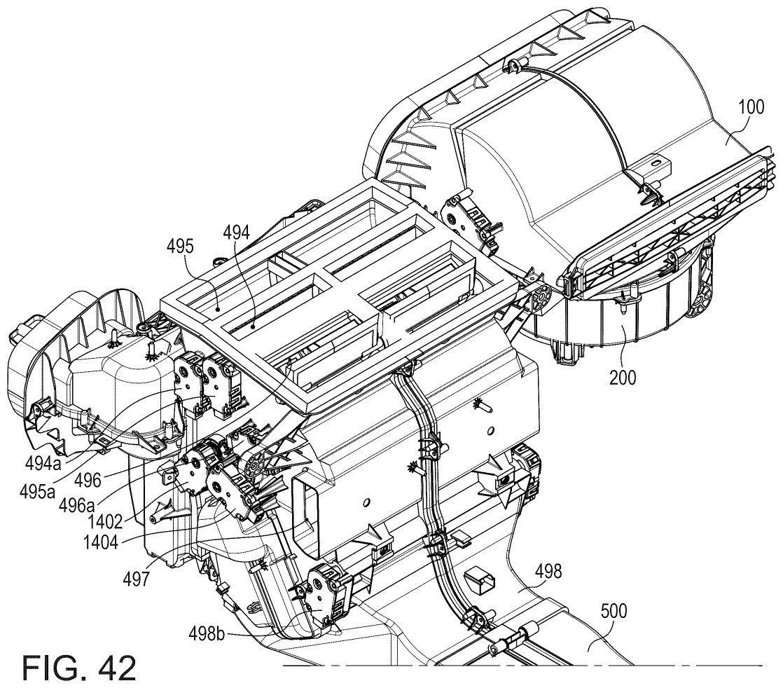

Turning now to FIGS. 1-43, an HVAC system 10 for a vehicle and specifically a passenger vehicle is provided. The vehicle may be a passenger vehicle that is configured to seat either 2 passengers, 4 passengers (including two or more in a second row), or 6 or more passengers in a third row. The vehicle may be a vehicle that is powered with an internal combustion engine, a vehicle powered solely by electricity, or a hybrid that can be powered from an internal combustion engine or by electricity as desired. Some aspects of the HVAC system 10 may be useful in other types of vehicles than passenger vehicles, such as truck, cranes, tractors or other farm equipment, or trains, boats, or aircraft. For the sake of brevity, the HVAC system 10 is discussed with respect to a passenger vehicle. One of ordinary skill in the art will comprehend with a thorough review and understanding of the disclosure how the system would work with other types of vehicles, and any specific changes needed are disclosed herein. Some aspects of the HVAC system disclosed herein are adapted to provide conditioned air to a second row and/or a third row of a vehicle. The HVAC system may be adapted to eliminate those features if appropriate, such as a vehicle that only has a first row (or even a single seat such as in a tractor or a crane), or only has first and second rows, but no third row, and the needed modifications would be readily understood by one of skill in the art with a review of this specification.

The HVAC system 10 generally includes an air intake housing 100, a fan housing 200 that receives air from the air intake housing 100 and when the fan is operating sends high pressure air out its discharge and into a diffuser 300. The diffuser 200 is connected to the intake of a heat treatment housing 400, that includes an evaporator 402 and a heater 403, and a plurality of doors that can direct the air that flows through the evaporator 410 through or bypassing the heater 403 and to send the air to different portions or systems within the vehicle, as further discussed herein. The heat treatment housing 400 is connected to a rear distributor 500 that receives air from the rear outlet of the heat treatment housing 400. The rear distributor duct 500 is provided to selectively direct air to various positions within a second row of a vehicle, such as a center console, the second row floor vents, and second row pillar vents. The distributor duct 500 further includes a separate flow path toward the third row. The third row may include one or more selection housings 600 that allow for air to flow to neither, one, or two different outlets within the third row of a vehicle. In some embodiments, the selection housing 600 may be provided to receive air directly from the heat treatment housing 400, such as to control the air flowing into the two flow paths of the rear distributor 500 (i.e. the flow path that ultimately flows to a second row vent and flow to a third row vent).

Turning now to FIGS. 1-6 an air intake housing 100 is provided. The air intake housing 100 includes a first air inlet 150 that is configured receive recirculation air (R schematic) that flows thereto from the passenger compartment of the vehicle (not shown), and typically from holes within a dashboard within the vehicle. The housing 100 has a second inlet 170 that is configured to receive fresh air from outside the vehicle. The housing 100 has an air outlet 180. The air that enters into the housing 110 flows to the air outlet 180. The air outlet 180 is connected to a fan housing 200 that is connected to the air intake housing, such that air flowing through the air outlet 180 flows to the suction of the fan 210.

The first air inlet 150 that flows directly into an inner volume 120 of the housing. The air inlet 150 may comprise a plurality of holes 151 that are disposed through the walls of the housing, such as the top wall 104, the right side wall 102 (passenger side for a vehicle configured to drive on the right side of the road) and the left side wall 103 (drivers side). In the embodiment depicted in the figures, the holes are 151 are disposed multiple walls that form the housing. The right and left walls 102, 103 may be planar and the center wall 104 extends between upper edges of the right and left walls. The curve of the center wall 104 may a continuous curve, such that the one or more valves 129 (that rotate about valve shafts and based upon an operator 129a) extend along the inner surface of the curved center wall 104 as they change positions as discussed herein.

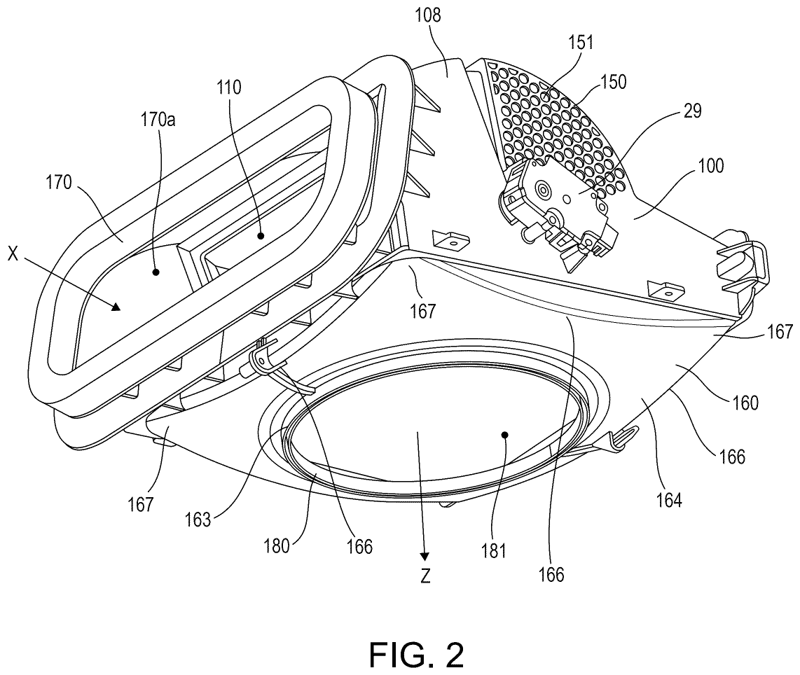

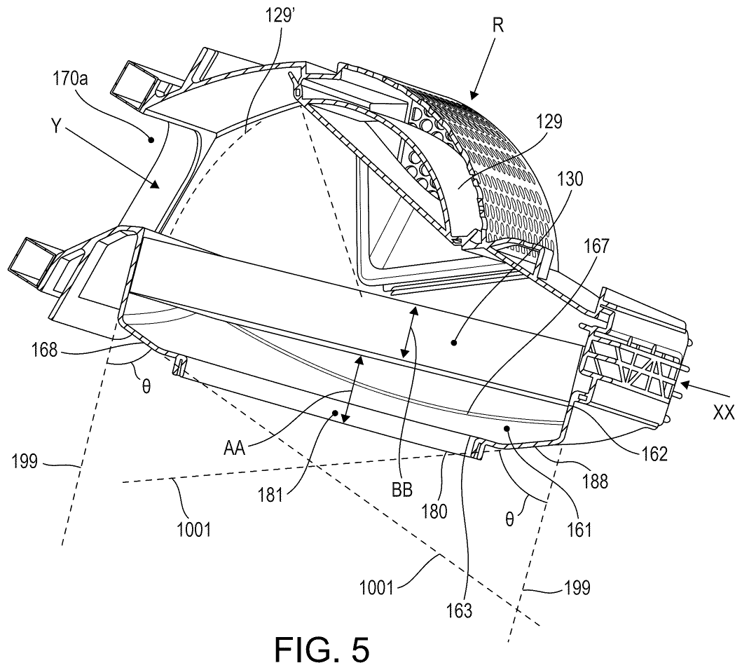

The air intake housing 100 additionally includes a second inlet 170 that is configured to receive air therein (X, schematic) that flows from outside the vehicle—i.e. fresh air. The fresh air X that flows into the inner volume 120 flows to the fan plenum 210 (air flow Z, schematic) (FIG. 2), based upon the position of the valve 129 (FIG. 5, depicting the valve 129 blocking the holes 151 for recirculation air flow), or the valve 129 may in a different position (rotated counter clock-wise from the position depicted in FIG. 5 to block the second inlet 170, depicted in broken lines and marked as 129′ on FIG. 5)) to allow flow through the holes 151 (recirculation air R) into the inner volume 120 and to the fan plenum 210.

The first intake housing 100 may receive a filter 132 that is provided above the fan plenum within a filter cavity 130 such that both the fresh air (X) and the recirculating air (R) that is received within the housing passes through a filter 30 before passing to the fan. The air filter 132 may be replaceable, and may be received within a filter cavity 130, with the arrow XX showing the direction that the filter 30 may be inserted into the filter cavity 130.

The filter cavity 130 is disposed above the air outlet 180, such that air flows through the filter 132 (when installed within the filter cavity 130) before flowing out to the air outlet 180 and to the fan housing 200. The inlet housing 100 includes a second space 161 that is downstream of the filter cavity 130, such that air flowing past the filter cavity flows through the second space 161 before reaching the air outlet 180.

The filter cavity 130 may have a thickness (BB, FIG. 5) which may be slightly wider than the width of the filter that is configured to be received within the filter cavity. For example, in some embodiments, the air filter 132 may be 30 mm thick, and the filter cavity 130 may be 35 mm thick (BB). The remaining thickness of the filter cavity may be for lower and in some embodiments upper rails that properly align the filter 132 within the filter cavity 130 when fully installed.

The second space 161 has a greater width (AA) (extending from the bottom of the filter cavity 130 (or in some embodiments the bottom of the filter 132 when installed)) than the height of the filter cavity (BB). This second space AA allows for air leaving the filter which is sometimes close to turbulent to restore back to laminar flow when entering the fan 210, which allows for the fan to more efficiently interact with the air.

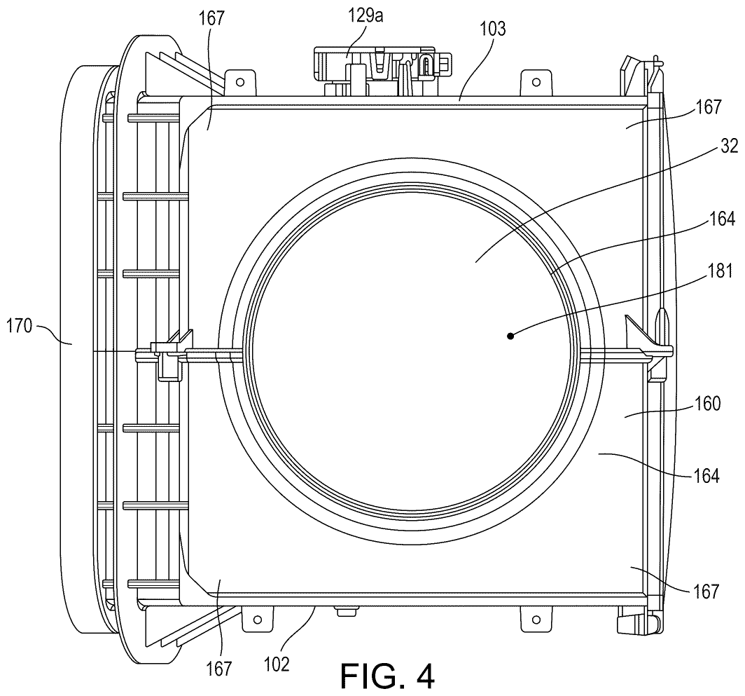

The inlet 162 of the second space 161 has the same geometry as the bottom of the filter space 130, or in other embodiments, the same cross-sectional area as the bottom opening of the filter space 130 through which air leaving the filter 132 can flow downwardly into the second space 161. The filter space 130 may be square or rectangular on cross-section (i.e. the direction into the page from viewing the air inlet housing 100 from bottom as depicted in FIG. 4), and the side walls 164 that form the second space 160 transitions along its length (in the direction of the downward arrow AA upon the page of FIG. 5) until reaching the outlet portion 163 of the second space 161 that is circular (FIG. 4).

In some embodiments, the wall 164 that defines the second space 161 transitions from a top portion to the outlet portion 163, with a curved profile, as best shown in FIGS. 2 and 5. The profile includes upstanding corners 167, and a curved downwardly side walls 166 between adjacent corners 167. As depicted in FIG. 5, the second space 160 may transition from the upper edge 167 of the side wall 166 toward the air outlet 180 along a planar portion 168 that forms an angle θ with a vertical line 199 (FIG. 5) that extends toward the fan housing 200. The formation of the combination of the curved side walls 166 and the planar portions 168 on the side walls provides for a gradual narrowing of the air flow path from the filter plenum 130 to the air outlet 180 that maximizes air flow and minimizes resistance.

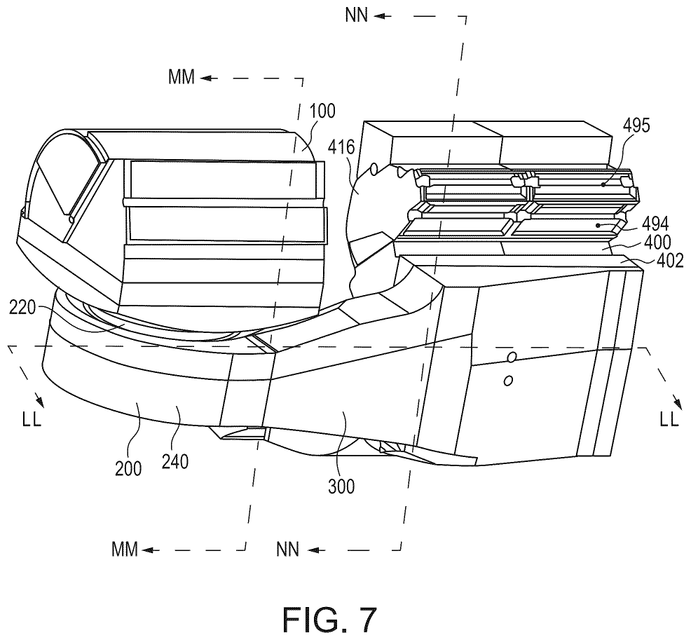

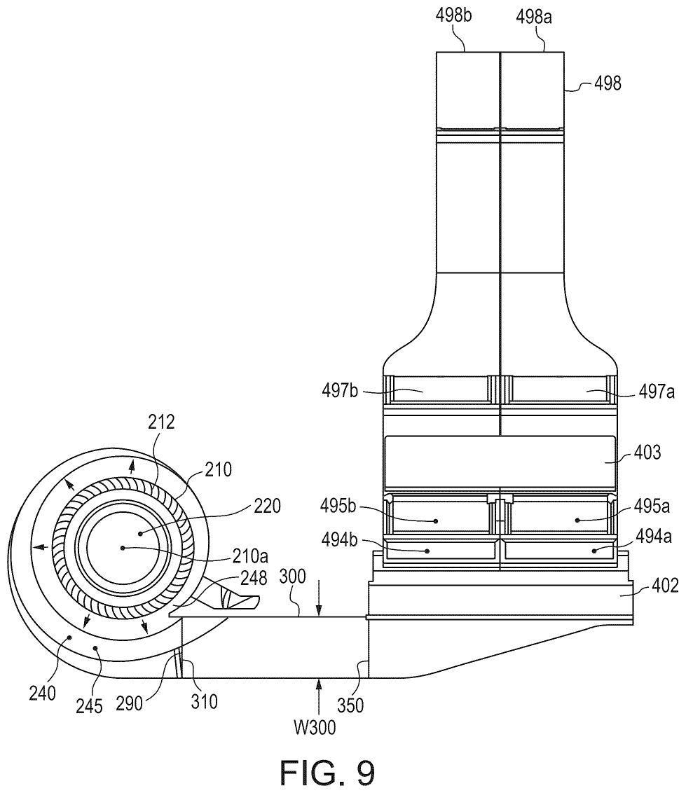

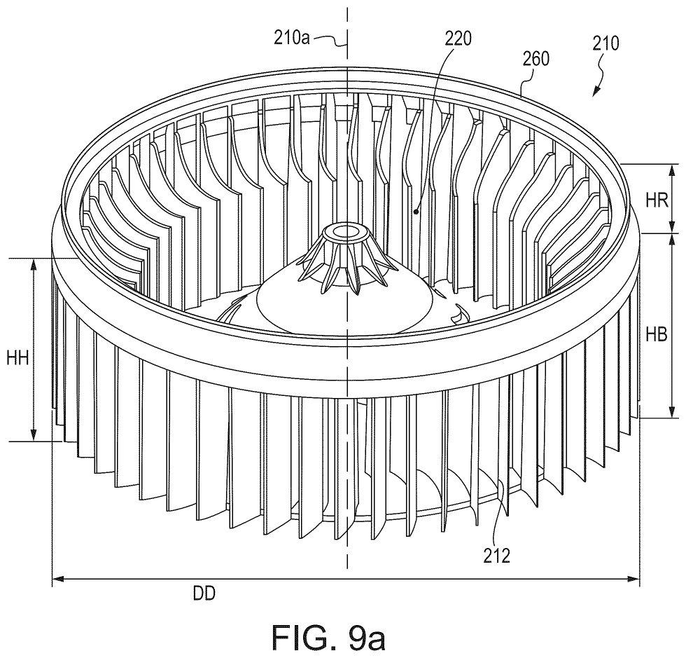

Turning now to FIGS. 7-11, a fan housing 200 and blower scroll 240, and a pathway 300 between the blower scroll 240 and the inlet of the air conditioning housing 400 is provided. The fan housing 200 includes an inlet 220 that receives air from the second space 161 of the inlet housing 100. The fan housing 200 supports a fan 210 that rotates about a rotational axis 210a (FIG. 9, FIG. 9a). As is conventional, when the fan 210 is rotating about its axis a low pressure (suction) is drawn at the inlet of the fan 220 which pulls air into the fan. Air is expelled radially substantially outward due to the position and the shape of the fan blades 212. The fan blades 212 are positioned around an outer circumference of the fan around the rotational axis 210a. In some embodiments, the fan blades 212 are spaced with equal spacing between adjacent fan blades around the entire circumference of the fan 210. The fan blades 212 are each supported by an upper rim 260 that extends about the circumference of the fan. The fan blades 212 each extend downwardly from the upper rim 260.

In a preferred embodiment, which is for high air flow HVAC systems (between 300 to 500 cfm maximum flow rates, but not limited to), the fan 210 is provided with the following dimensions. The fan has an effective height (HH) of 80 mm, a diameter (DD) of about 170 mm, and the blades have an effective height (HB) of 70 mm. In this embodiment, the height of the upper rim 260 is 10 mm (HR). Accordingly, the height of the upper rim 260 in this embodiment is 12.5% of the overall fan height. In other embodiments for high capacity fans, the upper rim may be between about 10% and 25% of the total height of the fan 210.

In this embodiment, the height of the fan 210 is about 47% of the diameter of the fan 210. In other embodiments for high air flow capacity, the height of the fan 210 may be between about 40% and 60% of the diameter of the fan 210, and more preferably within a range of about 45% to about 49%.

The scroll 240 is positioned outboard of the fan 210 and receives the air that leaves the air substantially radially away from the fan blades 212 when the fan rotates. The scroll includes an air path 245 that directs air to the exit 290 of the scroll 240, which mates with an inlet 310 of a pathway 300 toward the air conditioning housing 400 and specifically the evaporator 402 proximate to the opening in the air conditioning housing 400. In some embodiments, the air path 245 of the scroll may have an increasing cross-section around the circumference of the scroll, with the smallest area at the closed end of the scroll 248 and a largest area proximate to the exit 290. The cross-sectional area may continuously increase (for all of or a portion of) of the scroll from the closed end 248 to the exit 290. In some embodiments, the portion of the air path proximate to the exit 290 may have a constant cross-sectional area.

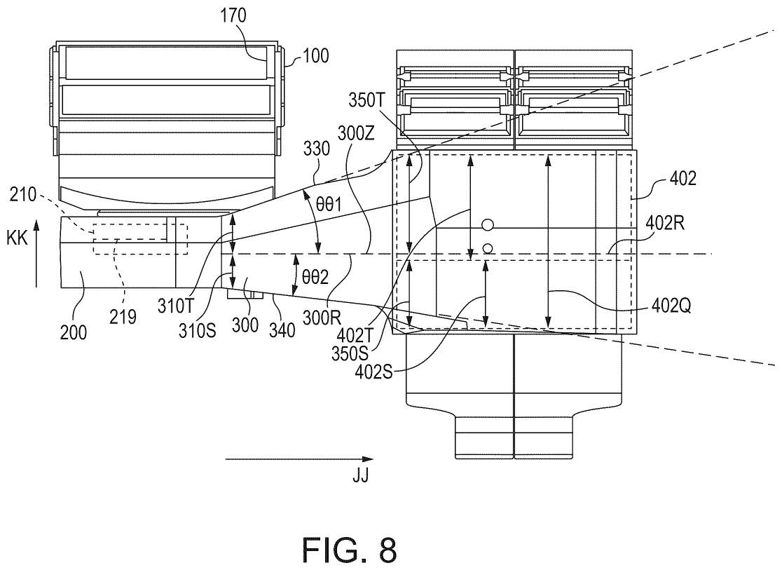

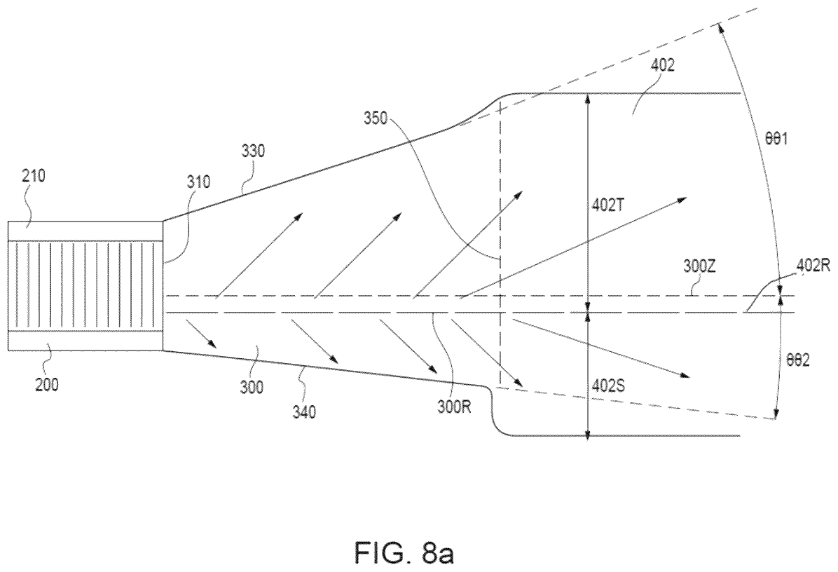

The pathway 300 (also referred to as a diffuser) extends between the fan housing 200 and the air conditioning housing 400. The pathway 300 receives relatively high speed air from the scroll 200 (through the exit 290) and increases the cross-sectional area for air flow along the length of the pathway, which decreases the velocity of the air, and results in an increase in the pressure of the air proximate to the outlet of the pathway 350. The pathway 300 cross-sectional area increase along its length (from the inlet 310 to the outlet 350) in order to increase the air flow path to a height that is the same as the height (402Q) of the evaporator 402 inlet (FIG. 8) so that the air flows to entire surface of the inlet of the evaporator 402 for proper operation of the evaporator 402.

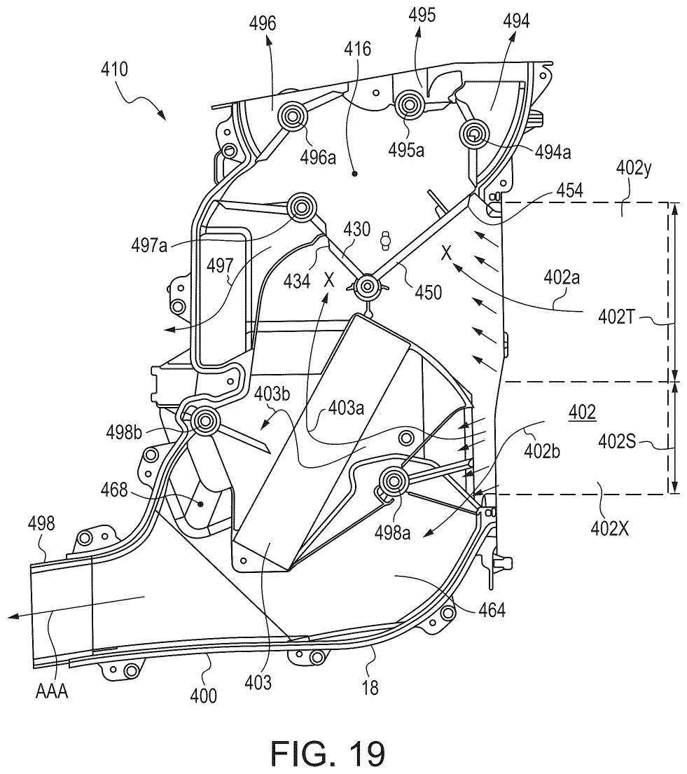

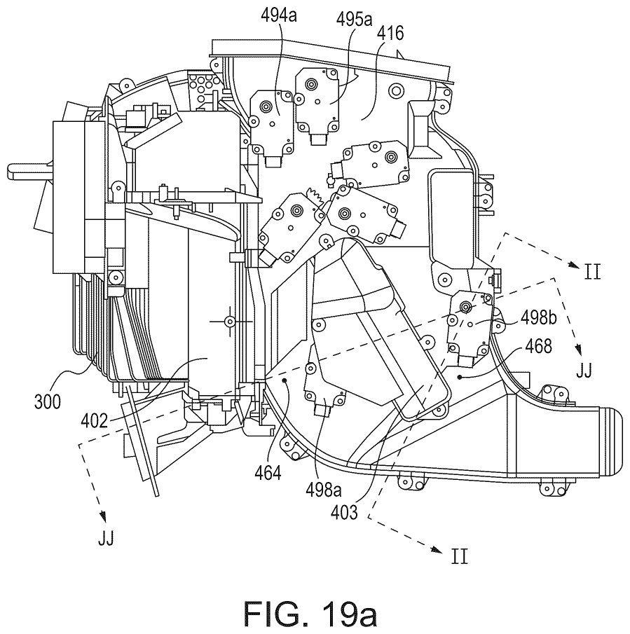

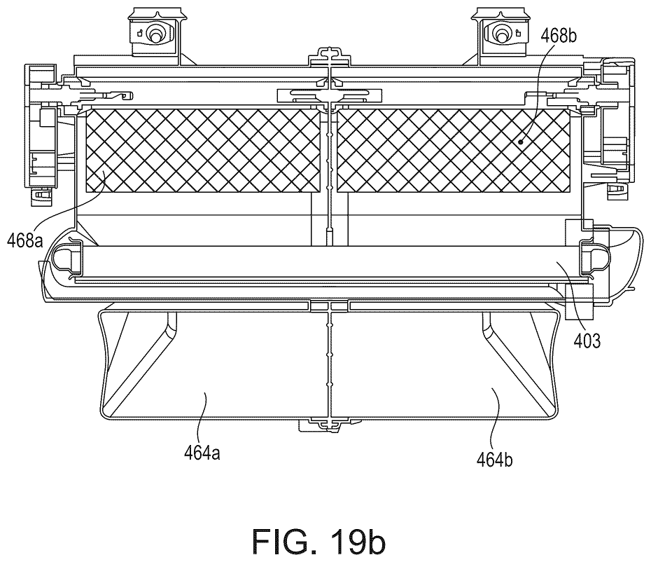

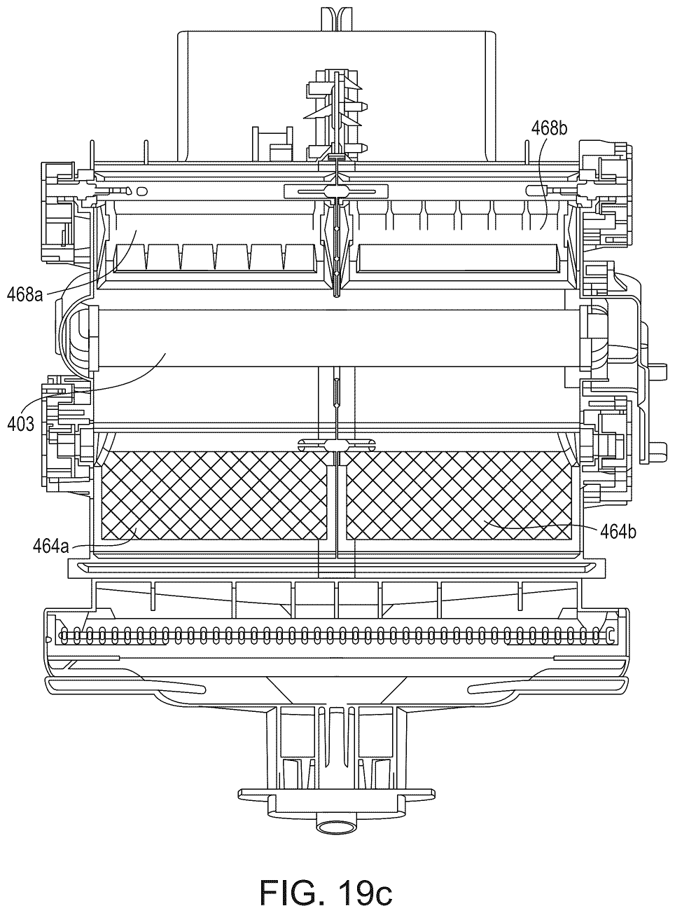

With reference to FIGS. 8 and 19, the air that enters an upper portion of the evaporator (402T, FIG. 19) ultimately flows to the upper portion 416 (mixing chamber, discussed below) of the air conditioning housing 400 and ultimately flows to an outlet that is directed to the front row of the vehicle (i.e. dashboard vents (496), floor vents (497) or to the defrost system (494) or demist system (495, when provided). Air that enters the lower portion of the evaporator (402S, FIG. 19) ultimately flows out of the rear outlet 498 of the housing 400 and ultimately flows to the second or third row of the passenger vehicle. Typically it is desired to have between 55-70% of the air flow that enters the air conditioning housing 400 flow to the upper portion 416 and between 30-45% of the air flow to the rear outlet 498. Accordingly, the pathway 300 is configured to direct the desired mass flow rate of total air from the fan toward the upper portion 402T of the evaporator (i.e. between about 55-70%) and the remainder be directed toward the lower portion 402S of the evaporator (the remaining 30-45%). The horizontal border within the evaporator (between the top 402T and the bottom 402S) is depicted as 402R, FIG. 8. The horizontal border 402R, may extend to a plane 300R through the pathway 30, where air above the plane 300R is above the plane 402R when the air enters the evaporator 402, and air below the plane 300R within the pathway 300 is below the plane 402R when entering the evaporator.

The pathway 300 is provided with a cross-sectional area that increases along its length (i.e. direction JJ, FIG. 8). In one preferred embodiment (which is designed for about 65% of the air that enters of the pathway 300 to be directed to the upper portion 402T of the evaporator 402) the cross-sectional area of at the pathway outlet 350 is between about 1.75 and about 3.5 times greater than the cross-sectional area at the pathway inlet 310.

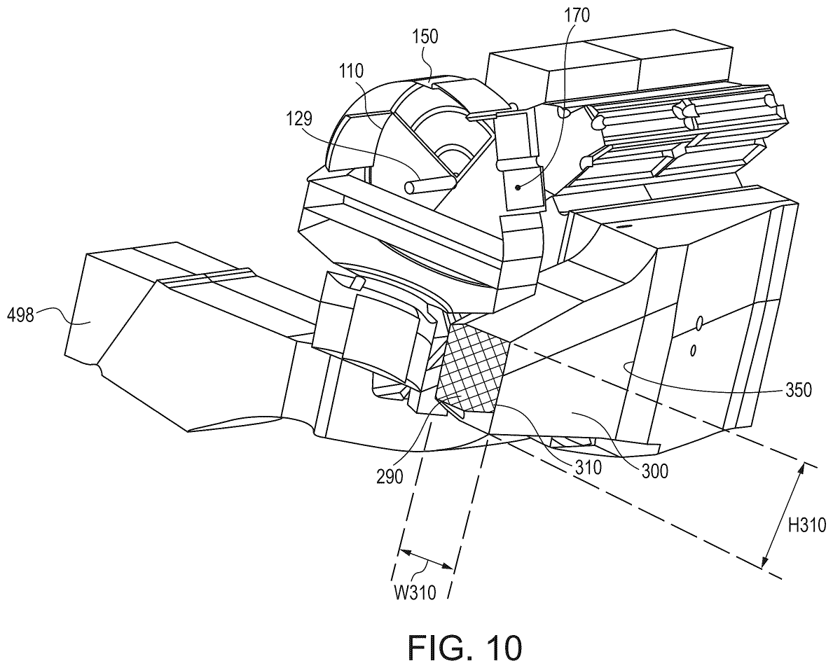

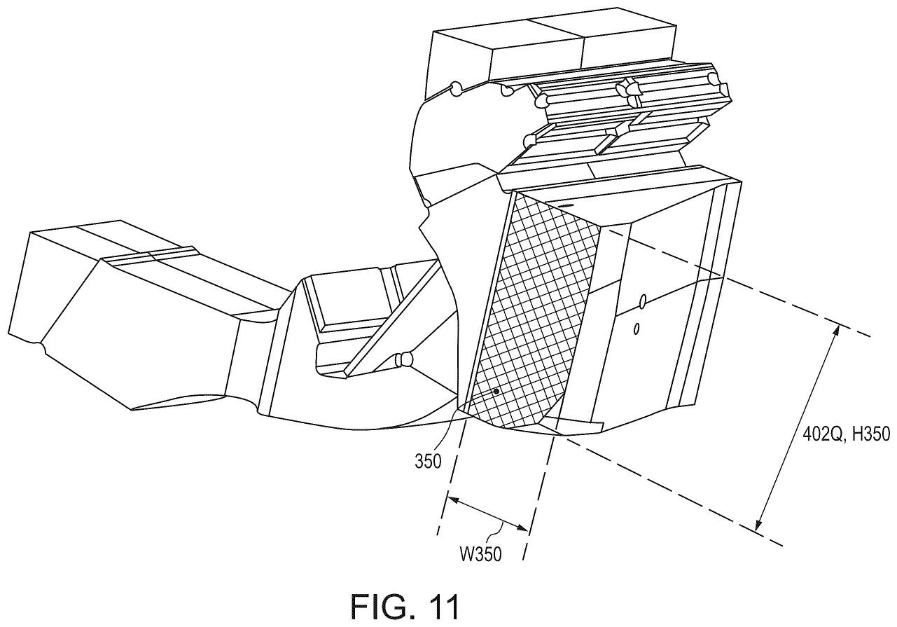

In one preferred embodiment, the increase in cross-sectional area increase is completely due to an increase in height (direction KK, FIG. 8) along the length (direction JJ) of the pathway 300, such that the width (W300, FIG. 9) is constant along the pathway 300, or in some embodiments along the overwhelming majority of the pathway 300. In this embodiment, the width is constant until just before the pathway reaches the air conditioning housing 400, with the width increasing just before the air conditioning housing (such as within 5 to 10 to 20 mm before reaching the air conditioning housing). The term overwhelming majority is defined herein to be at least 75% of the total value of the parameter—e.g. over 75% of the total length). In other embodiments, the width is constant within the pathway, and with the width for the airflow increases within the air conditioning housing 400 before reaching the evaporator (where the air must take a ninety degree turn to enter into the evaporator 402). In other embodiments, there may be a small increase in width of the pathway (perpendicular to directions KK and JJ (i.e. into and out of the page that FIG. 8 is printed on) depicted as W310 and W350 (FIGS. 10, 11).

FIG. 8a depicts schematically the air flow within the pathway 300 and the inlet portion of the air conditioning housing 400, which schematically depicts the air above the plane 300R within the pathway entering the evaporator 402 above plane 402R (FIG. 8), and the air below the plane 300R within the pathway entering the evaporator 402 below plane 402R. One of ordinary skill in the art with a thorough review and understanding of this specification and with routine experimentation and data gathering, will have the capability to determine the location of the plane 300R within the pathway 300 so that the total volume that enters the air conditioning housing 400 above the plane (and therefore enters the top portion of the evaporator) and the total volume that enters below the plane (and therefore enters the bottom portion of the evaporator 402) is at the desired percentages for a given fan speed.

The plane 300R within the pathway is established due to the increase in cross-section along the length (JJ) of the pathway 300 from the inlet (310) to the outlet (350). In a preferred embodiment, the top 330 of the pathway 300 extends upwardly (with respect to the height direction, KK) along the entire length of the pathway, as depicted in FIG. 8. In this embodiment, the bottom 340 of the pathway extends downwardly (with respect to the height direction KK) along the entire length of the pathway, as depicted in FIG. 8. In this preferred embodiment, the height of the top 330 increases at a linear rate from the inlet 310 and for an overwhelming majority of the length of the pathway, and the height of the bottom 340 decreases at a linear rate from the inlet 310 and for an overwhelming majority of the length of the pathway 300. In some embodiments, the height of the top and the bottom may increase and decrease (respectively) for the entire length of the pathway. In some embodiments, the top 330 may extend along a plane and the bottom may extend along a plane (such that outer cross-section of the pathway is rectangular (edges along axis KK, and the direction into and out of the page that FIG. 8 is printed on). In other embodiments, the top and or the bottom may be formed by two or more planes that come together to collectively form the top, and the bottom may be formed by two or more planes that come together to form the top. Still alternatively, the top and or the bottom may be curved surfaces, or a combination of planar and curved surfaces. In these embodiments, the shape of cross-section of the pathway may be generally the same, with the height of the cross-section increasing along its length (and the width of the top and bottom remaining constant, or only slightly increasing along the length (JJ) as discussed above.

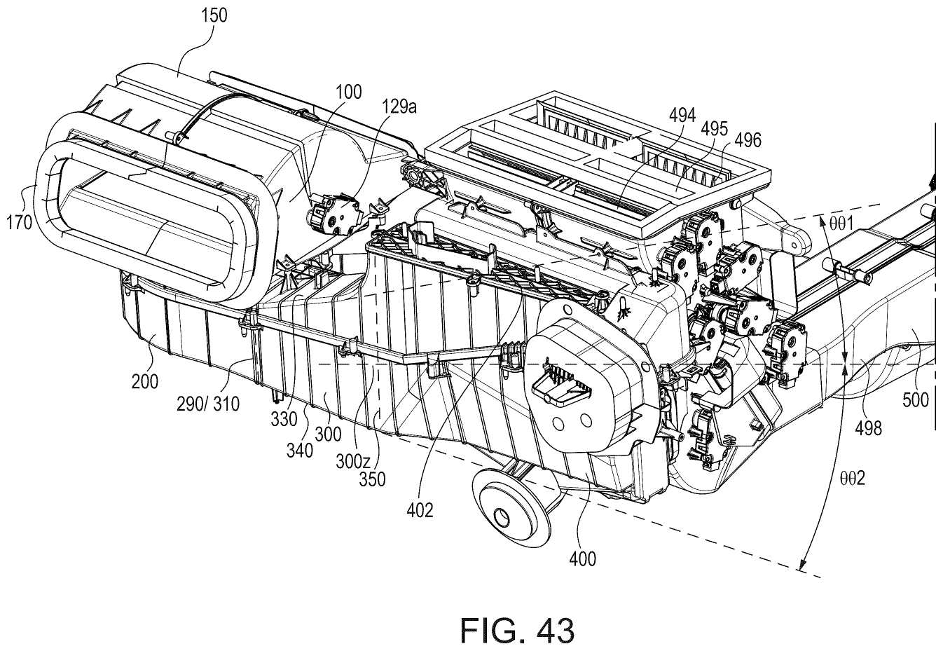

In a preferred embodiment, and as depicted in FIGS. 8 and 43, the top 330 is formed by a planar surface, and extends at an angle θθ1 with respect to a line 300Z that is perpendicular to a cross-section of the inlet 310 into the pathway (cross-section formed by height (KK) and direction into and out of page that FIG. 8 is printed on). In FIG. 8, the line 300Z is depicted as along the plane 300R, but in some embodiments, the line 300Z may be at an angle to the plane 300R depending upon the construction of the pathway 300, as discussed herein. In this preferred embodiment, the bottom 340 is formed by a planar surface, and extends at an angle θθ2 with respect to the line 300Z.

In some embodiments the top 330 extends along the same direction for the entire length of the pathway, while in other embodiments the top extends in the same direction for an overwhelming length of the pathway. Similarly, in some embodiments the bottom 340 extends along the same direction for the entire length of the pathway, while in other embodiments the bottom extends in the same direction for an overwhelming length of the pathway. In the embodiments where the orientation of the top or bottom changes, the change includes a rapidly increasing top 330 (height portion) (or rapidly decreasing height for the bottom 340), with the increase/decrease in height occurring just before the transition to from the pathway outlet 350 to the air conditioning housing 400, as discussed herein. The rapidly increasing/decreasing height portions may be closely proximate to the outlet 350 of the pathway, which is defined no more than the last 25% of the length of the pathway, and in some embodiments, the rapidly increasing and/or decreasing height portions occur at the last about 15% or 10% or 5% of the length of the pathway before the outlet 350.

In the preferred embodiment, angles θθ1 and θθ2 are each acute angles with the angle θθ1 being larger than θθ2. In the preferred embodiment, the angle θθ1 is about 12 degrees and the angle θθ2 is about 6 degrees. In other preferred embodiments, the angle θθ1 may be within a range of about 12-15 degrees, or within a range of about 10-20 degrees, and the angle θθ2 is within a range of about 4-7 degrees, or within a range of about 3 to 15 degrees.

The inlet 310 of the pathway 300 includes an upper space (310T) above the plane 300R and a space (310S) below the plane 300R. Similarly, the outlet 350 has an upper space (350T) above the plane 300R and a lower space (350S) below the plane 300Z. In a preferred embodiment, the ratio of the height of the upper space at the outlet (350T) to the upper space at the inlet (310T) is between 1.75 and 2.5. In the preferred embodiment, the ratio of the height of the lower space at the outlet (350S) to the lower space at the inlet (320S) is between 1.5 to 2.25). As discussed above, because in preferred embodiments, angle θθ2 is smaller than angle θθ1, the ratio for the lower spaces is a smaller number than the ratio of the upper spaces. This phenomenon of the top 330 providing a higher rate of increase in cross-sectional area than the bottom 340 is important to the proper flow alignment of air that enters the evaporator 402, as discussed above.

In some embodiments, the pathway 300 is constructed such that the plane 300R is positioned within the pathway 300, and the pathway is positioned with respect to the scroll 240 and the fan housing 200, such that the plane 300R is positioned below a midpoint (219, FIG. 8) in the height of the fan 210.

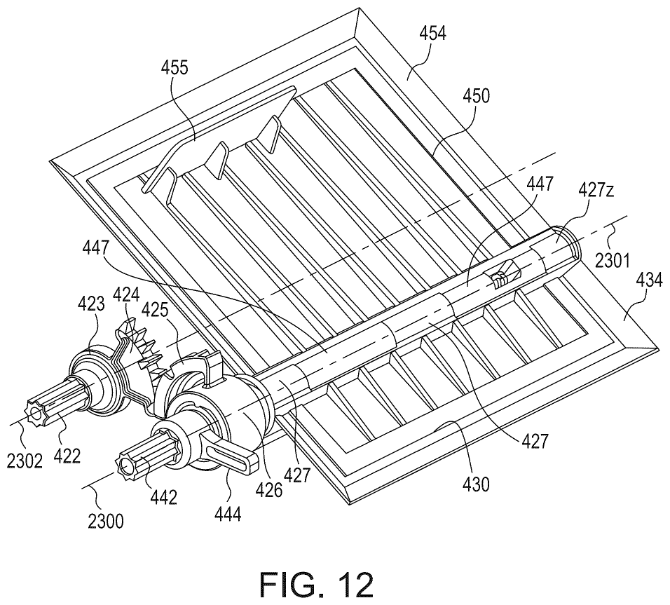

Turning now to FIGS. 12-25b, an air conditioning housing 400 (or heat treatment housing) is provided. The air conditioning housing 400 is configured to receive high pressure air from the fan and the diffuser 200/300, and control both the temperature and the outputs from which the air flows into the passenger compartment of the vehicle. In some embodiments, the heat air conditioning housing includes an evaporator 402 which during operation removes heat from the air that flows therethrough, and a heater 403 that adds heat to the air that flows therethrough. The evaporator 402 and the heater 403 may both be components of a heat pump system, with refrigerant flowing therethrough in a closed loop as urged by a compressor (not shown, outside of the HVAC system) as well as the changes of state of the refrigerant through the various components of the heat pump system. In this embodiment, the heater 403 is a heat pump heater that receives refrigerant from the compressor and gives up heat to the air that flows past the heat pump heater. In other embodiments, the heater may be in the form of a condenser. In some embodiments, the heater 403 includes a heat pump heater (part of a heat pump system) and an auxiliary heater (such as a PTC heater or a resistance heater) that can be selectively operated by the HVAC controller 1000 to provide additional heat to the air that flows therethrough (403a, schematic). In other embodiments, such as embodiments where the HVAC system is used with an internal combustion engine, the heater 403 may be a heat exchanger that receives engine coolant therethrough that has recently flowed past the engine to gain heat to heat the air that flows past the heater 403.

The air conditioning housing receives air from the diffuser 300 (FD, schematic), and in some embodiments, sends all air received from the diffuser 300 past the evaporator 402. The leaving the evaporator 402 may flow in various paths through the housing 400 to be heated (if desired) and ported to the desired flow paths to the various outlets within the vehicle, as discussed below. In other embodiments a bypass line and a valve may be provided to allow air from the fan 210 (by way of the diffuser 200) to flow into the housing 400 and bypass the evaporator 402.

Turning now to FIGS. 12-25b, an air mixing damper system 410, and an assembly 400 that supports one or more air mixing damper systems 410 is provided. The assembly 400 is configured to be used in a vehicle to allow for control of hot air from a hot air source (403) and the control of cold air (402) from a cold air source. The cold air source 402 may be air flow from the evaporator of an air conditioning system or another cooling system that may be provided within a vehicle. The hot air source 403 may be a heat pump heater of a heat pump system or a condenser of a refrigeration system. The hot air source may also include a heating coil, a PTC heater, or resistance electrical heaters, which may be instead of the heat pump heater or in series with the heat pump heater. In embodiments where the vehicle includes an internal combustion engine, the engine itself including all systems that generate heat within engine or are used in order to remove generated heat from the engine may be used to provide heat to the hot air source, via a coolant system.

The assembly 400, as discussed in further detail below includes a mixing chamber 416 is configured to receive air from one or both of the hot and cold air sources 402, 403 (via flows 402a, 403a) and provide a space for cold and hot air received to mix and for air to flow from the mixing chamber 416 to various systems within the vehicle, such as the defrost system (494, control valve 494a), the de-mist system (495, 495a control valve), one or more air flow registers located on the dashboard of the vehicle 496, 496a), and a floor ventilation system (497, 497a). The assembly 400 is controlled by the HVAC controller 1000 (schematic, FIG. 19), that based upon the inputs provided by the vehicle occupants (i.e. desired use of air conditioning or heat in the various spaces within the vehicle, and the desired temperature within the space, and the desired air flow speed to various zones within the vehicle; the desired use of the vehicles front windshield defrost system) controls the operation of the various valves (e.g. 494a, 495a) to allow or prevent air flow to each system, and controls the operation of the cold air system and the hot air system (controls the fan speed for hot air 403a, controls the fan speed for cold air 402a, and controls the operation of the compressor for the heat pump system—or air conditioning system) as needed to produce the desired air flows.

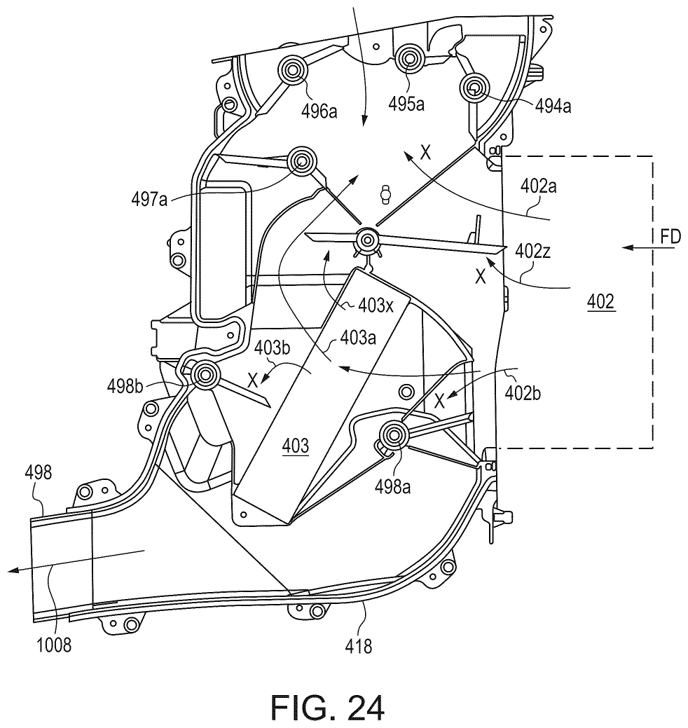

The air mixing damper system 410 is provided to control the flow rate as well as prevent or allow flow to the mixing chamber from both the hot air and the cold air sources. In some embodiments, the air mixing damper system 410 can be used to allow flow in a throttled manner, such that some flow of hot and/or cold air can flow into the mixing chamber 416, but some flow is prevented from flowing into the mixing chamber (schematically depicted on FIG. 24 as 402z, 403z. The HVAC controller 1000 can be programmed to move the first and second doors 430, 450 as appropriate to a throttled position as needed-either due to programmed door settings based upon the HVAC settings in the vehicle at the current time, or determined in real-time by the controller based upon feedback control. The disclosure herein will describe the air mixing damping system 410 specifically with respect to the open and closed positions, but one of ordinary skill in the art with a thorough review of the subject specification and figures will readily comprehend how the first and second doors 430, 450 may be positioned into intermediate throttling positions.

The assembly 400 including the air mixing damper 410 (and in some embodiments the use of two air mixing damper systems 410 that direct air to two different mixing chambers 416, one for a zone to direct air toward the driver's seat portion of the vehicle and a separate zone 417 to direct air toward the passenger's seat portion of the vehicle, through a rear outlet 498) has been identified to allow for several improvements over conventional air flow control systems, such as systems where the first and second doors (e.g. a first door to allow or prevent flow of hot air-similar to flow 403, and a second door to allow or prevent flow of cold air-similar to flow 402) are moved together in unison and can't move with respect to each other. In these prior embodiments, the HVAC controller often needed to throttle hot or cold air flow with isolation valves that led from the mixing chamber 416 directly to the specific system (e.g. the isolation valve 416 to the dash ventilation system, air flow 416a), and the system needed complex geometries and narrowed flow paths to ensure the proper air flow. The use of the air mixing damper system 410 has been experimentally identified to lower the overall noise in the passenger compartment from noise levels with conventional systems in an unexpected or unpredictable manner. Also, the use of the air mixing damper system 410 in some circumstances allows for less air flow (i.e. lower fan speeds) and shorter duty cycles of the air conditioning system to achieve the desired temperatures and flows to the monitored spaces, which has resulted in measured lower electrical power requirements with the use of a system with the air mixing damper system 410.

Turning now to FIGS. 12-18, the air mixing damper system 410 is provided. The system 410 is rotatably fixed within a housing 418, and the housing 418 is arranged to establish the air flow paths (e.g. cold air 402, hot air 403) and outlet flow paths (e.g. path to defrost 494) with the air mixing damper system 410 positioned to control air to enter into the mixing chamber 416, as discussed herein. In situations where the first and/or second doors 430, 450 are in the closed position, the doors block the flow paths and the edges of the doors (e.g. 434, 454) contact or come into close proximity with walls or features of the housing 418 to prevent air flow. In situations where the first and/or second doors 430, 450 are in the open position, the doors are rotated away from contact or close proximity to the walls or features of the housing 418 to allow air flow. FIGS. 19-23 depict the housing 418, and specifically a portion of the housing 418 that interacts with the air flow paths to the dash vents and the floor ventilation system that of the driver's position. In embodiments, where a second air mixing damper system 410 is provided to control air flow to proximate to the passenger's seat area, the housing would interact with that air mixing damper system 410 in a similar manner. In embodiments with separate flows to the driver side (depicted in the figures) and the passenger side (similar structure to the structure in the figures) the housing 410 includes a center wall that separates the driver and passenger sides of the housing. In embodiments with a wall, the wall extends across the evaporator 402 and in some embodiments across the heater 403.

The air mixing damper system 410 includes a first door 430, which is used to allow, prevent, or throttle air flow from the hot air system 403 (flow 403a), and a second door 450, which is used to allow, prevent, or throttle air flow from the cold air system 402 (flow 402a).

The first door 430 is fixed to a first shaft 427, such that rotation of the first shaft 427 causes rotation of the first door 430 (with respect to the housing 418). The first shaft 427 may be hollow and extends along a first axis 2300. The first door 430 is rotated by a first actuator 2104 that is fixed to the housing 418. The first actuator 2104 rotates in input 422 that extends along an axis 2302 that is spaced from but parallel to the first axis 2300. The input 422 may be a shaft that has one or more non-circular features to allow the first actuator 2104 to transfer torque to the input 422. In the embodiment depicted, the input 422 has a plurality of radial outward features that interact with corresponding features in the actuator 2104 (not shown), but in other embodiments the input may have a D shaped shaft or non-circular engagement features that interact along the axis 2302.

The input 422 fixedly supports a first hub 423 that includes a radially extending gear profile 424. The gear profile 424 is meshed with a corresponding gear profile 425 of a second hub 426, such that rotation of the input causes rotation of the first hub 423 and first gear profile 424, which causes meshed corresponding rotation of the second gear profile 425 and rotation of the second hub 426. The first shaft 427 is fixed to the second hub 426 such that the first shaft 427 rotates when the second hub 426 rotates.

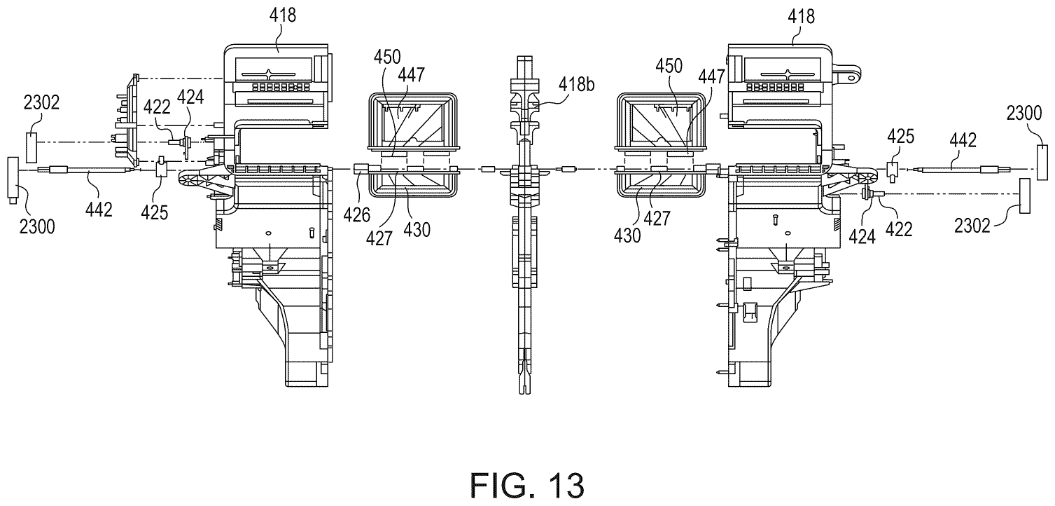

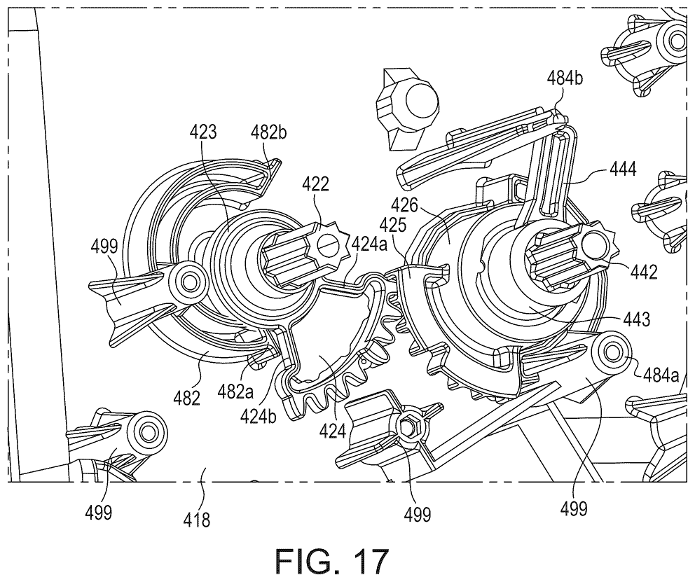

As best understood with reference to FIGS. 13, 16, 19, 25a, and 25b, the first actuator 1402, the first hub 423, and the second hub 426 (and their corresponding gear teeth) may be positioned on an outside surface of the housing 418. In some embodiments, a feature 482 may be provided outboard of the first hub 423 and the gear teeth 424, and the feature is positioned, sized and shaped to mechanically limit the range of travel of the first hub 423. In the depicted embodiment, the feature 482 is a “C” shape and is concentric with the first hub 423, with the two end faces 482a, 482b positioned to contact opposite ends of the gear teeth 424 when the first hub 423 is at both ranges of potential rotation. FIG. 17 depicts the gear teeth 424 (and specifically surface 24b) in contact with end 482a of the feature, which results in the first door being positioned as depicted in FIGS. 8 (410)—i.e. to prevent flow of air past the first door (hot air 403 flow prevented). As can be understood, when the first hub 423 is positioned such that the first door is fully open, the opposite surface 424a of the gear teeth 424 contacts the opposite end surface 482b of the feature 482.

In some embodiments, a cover (not shown) is provided upon the housing 416 to enclose the first and first and second actuators 1402, 1404, the first and second hubs 423, 426 to prevent mechanical interference with these components.

The first shaft 427 extends through a hole (not shown) in the housing 418 to enter into the enclosed space of the housing and to connect to the first door 430.

The second door 450 is fixed to the second shaft 447, such that rotation of the second shaft 447 causes rotation of the second door 450 (with respect to the housing 418).

The second shaft 447 may be hollow and extends along a second axis 2301 that is co-linear with the first axis 2300. A third shaft 442 extends through the second shaft 447 and the first shaft 427, and the third shaft 442 is fixed to the second shaft 447. The third shaft 442 and the second shaft 447 can freely rotate with respect to the first shaft 427.

In some embodiments, the first and second shafts 427, 447 are arranged similar to a conventional door hinge such that the first shaft 427 has two or more round and hollow components that are spaced from each other, and the second shaft 447 has two or more round and hollow components that are spaced from each other, with the first and second shafts 427, 447 arranged such that the second shaft components 447 are positioned within spaces between the first shaft components 427, at the inner spaces of the first shaft. In some embodiments, the first shaft 427 has three components and two spaces 427a, and the second shaft 447 has two components that extend within the two spaces. In other embodiments. In other embodiments, the first and second shafts may have the same number of components and spaces (with each shaft having a “space” after the shaft ends) such that the order is first, second, first, second (etc. as desired).

The first door 430 bridges across and outside of the components of the second shaft 447, and the second door 450 bridges across and outside of the components of the first shaft 427.

The one end of the first shaft 427z forms a bearing to support an end 442z of the third shaft 442. In embodiments where the first and second shafts 427, 447 are arranged line opposing cylindrical portions of a conventional door hinge, the third shaft 442 extends coaxially within the apertures of the first and second shafts like the pin of a the conventional door hinge.

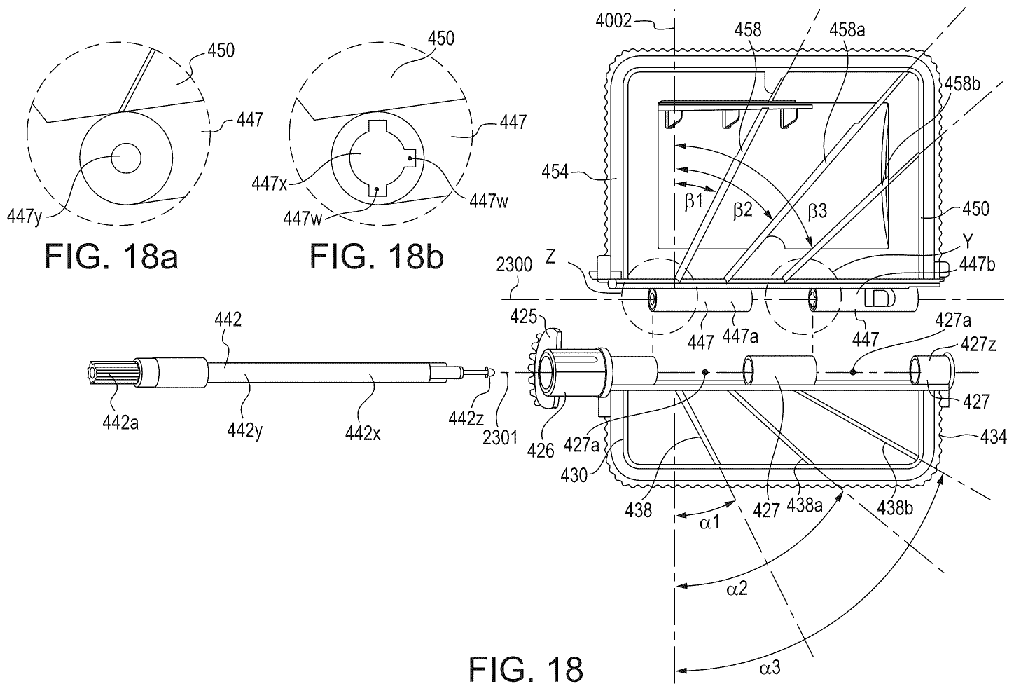

The third shaft 442 is rotatably fixed to the second shaft 447 such that torque applied to the third shaft 442, as discussed below, is transferred to the second shaft 447. As best understood with reference to FIGS. 18-18b, the third shaft 442 extends through the first shaft 427 (and the tip 442z is supported by a bearing 427z in the first shaft 427). In some embodiments, a portion of the third shaft 442 that extend through the first and second shafts 427, 447 may have a flat portion to establish a “D” shaped shaft with the aperture 447y in the second shaft 447 establishing a corresponding D shape. Alternatively, in some embodiments, the third shaft may have a portion 442x that includes one more radially extending lobes 442w with the aperture 447x in the second shaft having a plurality of voids 447w to closely accept the respective one or more radially extending lobes of the third shaft 442. The apertures through the first shaft 427 (and specifically the first shaft 427 portions away from the bearing portion 427z) have a larger aperture to allow the third shaft 442 to freely rotate within the first shaft 427 without contacting the first shaft 427. In the depicted embodiment, the second portion 447b of the second shaft 447 (i.e. the second shaft portion further from the second hub 426) may have a smaller diameter hole 447z and include the voids 447w to mate with the corresponding portion of the third shaft 442. The first portion 447a (i.e. the second shaft portion closer to the second hub 426) may have an aperture 447y that is large enough to allow the portion 442x of the third shaft 442 to pass through, but sized to interact with the D-shaped portion 442y. Other arrangements to rotatably fix the third shaft 442 to the second shaft 447 but allow rotation of the third shaft 442 with respect to the first shaft 427 may be provided.

The third shaft is configured to be fixed to the second actuator 1404. In the depicted embodiment, the third shaft 442 is aligned along the second axis 2302. Rotation of the second actuator 1404 causes rotation of the third shaft 442, which causes rotation of the second shaft 447 and the second door 450.

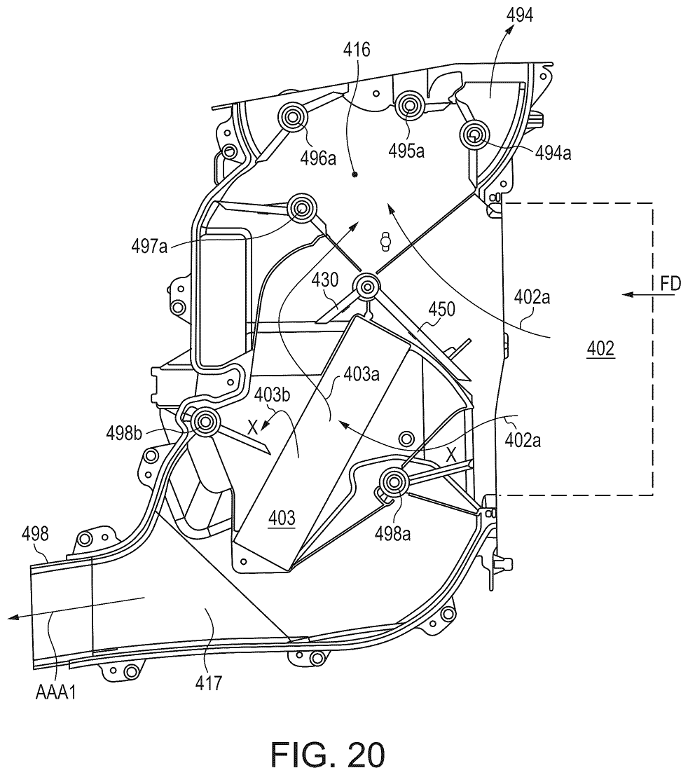

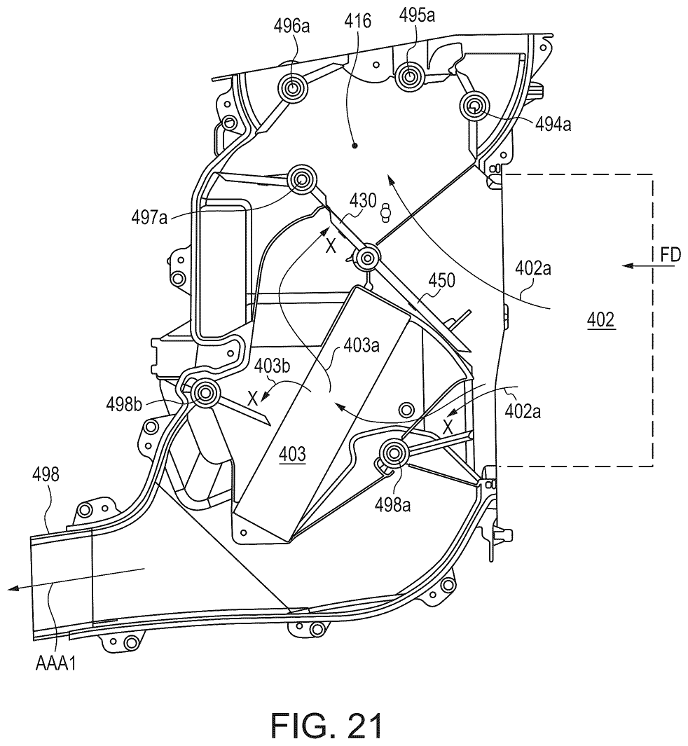

As with the first actuator 1402, the second actuator 1404 is positioned on the outside surface of the housing 418. The housing 418 may include one or two second features 484 that are positioned to limit the travel of the third shaft 442. For example, the third shaft 442 may be support and be fixed to a third hub 443, with a radial leg 444 extending from the third hub 443. The second features 484 are positioned to be contacted by the radial leg 444 when the third shaft 442—and therefore the second door 450—have reached the extent of the desired range of rotation of the second door 450 to establish the open and closed positions (the second door 450 allows, prevents, or throttles flow of cold air 402a from the cold air system 402). In the position depicted in FIG. 17, the radial leg is contacting one of the second features 484 and the second door 450 is in the fully open position (FIGS. 20, 21). It will be easily understood by one of ordinary skill in the art with a thorough review of this specification and figures that a second feature can be provided and positioned to be engaged by the radial leg 444 when the second door 450 is in the fully closed position (with respect to the housing 418). In the embodiment depicted in FIG. 17 the second feature 484 is a post that is contacted by the radial leg, but in other embodiments the second feature 484 may be a c-shaped feature similar to the first feature 482. In the embodiment depicted in FIG. 17 the second feature 484 extends further from the planar surface of the housing 418 that supports the assembly than the second feature 482 because of the relatively positions of the first, second, and third hubs 423, 426, 443 with respect to the housing 418. As discussed above, the cover (not shown) may cover the second actuator 2106, second hub 443 and the radial leg 444.

The first door 430 and the second door 450 can be rotated independently of each other by the respective first and second actuators 1402, 1404. The first and second doors 430, 450 can each be moved between their open and closed positions (with respect to the features of the housing 418) and various throttled positions between the fully open and closed positions. The first and second doors 430, 450 can be maintained in their current positions, either for a set period of time, or in some embodiments until the receipt of a new control input or until a set time for the position has expired—or until the HVAC controller 1000 identifies that the position must be adjusted due to the feedback control.

The rotation of the first and second doors 430, 450 is controlled by the HVAC controller 1000, via signals that are sent to the respective first and second actuators. The positions of the first and second doors 430, 450 are controlled either by pre-programed positioned table based upon the desired air flow and air temperature parameters set by the user. In some embodiments, the position of the first and second doors 430, 450 (including being throttled, and a specific throttled position of each door) may be positioned by the controller based upon feedback control-based upon sensed temperatures either within the system 400 or within the controlled space within the vehicle that receives the specific air flow. In addition the HVAC controller 1000 controlling first and second valve position 430, 450, the controller may also control the fan speed for the hot and cold air flows (403a, 402a) as well as the duty cycle of the heating system 403 or cooling system 402.

In some embodiments and as best depicted in FIG. 18, one or both of the first and second doors 430, 450 may have one or more elongate ribs (438, 438a, 438b; 458, 458a, 458b) that extend outwardly from the planar surface of the respective door 430, 450. The ribs may be provided to provide additional strength to the door to prevent bending, particularly when the door is closed with a tight seal against the housing, as discussed below—to provide strength to the door against the pressure that the air flow (402a—second door 450; 403a—first door 430) imparts against the door's surface. In some embodiments, the ribs may be either parallel to a line 4002 that perpendicular to the first axis 2300 (2301), or lines parallel to the first axis. In other embodiments, the ribs may be at an acute angle to the line 4002 (α—first door 430), (β—second door 450). In some embodiments, multiple lines may be provided at different acute angles—e.g. α1, α2, α3—first door 430, and β1, β2, β3, second door 450). Other arrangements, orientations, and shapes of the ribs may be provided to add strength of to the doors against bending, as well as in some embodiments to interact with the air that flows past the door to act as vanes to direct the air into the mixing chamber 416 or in certain directions. Alternatively or additionally, the ribs may be sized and shaped to cause local turbulent flow of a portion of the air to aid in mixing or for other purposes.

The doors 430, 450 may support structures that extend outward from the door such as element 455 (FIG. 12). These may alter the air flow. Alternatively, the features may interact with portions of the housing to change the air flow path (aperture size for air flow thereacross when fully open or in certain throttle positions. One of ordinary skill in the art would be able to design a door with desired ribs 438/458 or elements 455 that effect the air flow past the respective door, or alter the air flow opening during door movement or in throttled positions, and developing these features upon the door upon a thorough review and understanding of this specification can be provided and optimized with only routine experimentation.

In some embodiments, one or both of the first and second doors 430, 450 may have an edge surface or edge portion that as a coating or a material placed thereon that is provided to allow for tight air seal with the corresponding portions of the housing 418 when the respective door 430, 450 is in the closed position. In some embodiments, the coating or material may be an elastomeric material that is somewhat or substantially flexible to locally deform when contacting a surface of the housing 418 to establish a tight engagement, to eliminate or minimize the ability of air to flow therepast. The elastomeric coating may also benefit from dampening any noise when the surface of the door impacts upon the housing 418 to minimize the noise or vibrations that travels to the passenger compartment of the vehicle during operation.

As shown in FIGS. 19-23, a second flow path 498 is may be provided from the assembly 410 and to a remote space within the vehicle that may be independently controlled from a space proximate to the driver and passenger seat area. The flowpath 498 receives air flow from the cold system (flow 402b) and flow from the hot system (403b), and may be independently controlled with dedicated cold air and hot air valves 498a, 498b. Flow through the second flow path 498 does not flow past the air mixing damper system 410, but instead travels directly to the valves 498a, and 498b from the respective cold and hot air systems, such that air flowing to the second flow path 498 does not flow past, and is not blocked by the first and second doors 430, 450.

The housing may include a cool air plenum 464 and a warm air plenum 468 (FIG. 19) that are each disposed downstream of the respective doors 498a (isolates or allows flow 402b to the cool air plenum 464, and 498b (isolates or allows flow 403b to the warm air plenum 468). As depicted in FIGS. 19a-c, in a preferred embodiment, the smallest cross-section portion of each of the cool air plenum 464 and the warm air plenum 468 each have substantially the same cross-sectional area-shown in cross-hatching on FIGS. 19b and 19c, with FIG. 19b showing the warm air plenum 468a/468b (section II-II of FIG. 19a) and FIG. 19c showing the cold air plenum 464a/464b (section JJ-JJ of FIG. 19a, to promote same amount of warm air or cold air flowing through the outlet 498 and to the distributor duct 500, discussed below. In a preferred embodiment, the minimum cross-sectional area in both the cool and warm air plenums 464, 468 is the same as the cross-sectional area of the rear outlet 498 of the housing 400, or the inlet 530 of the distributor duct 500, discussed below. As discussed herein, the rear outlet 498 may be two rear outlets that allow for separate parallel flow 498a (driver side), 498b (passenger side), and the warm and cold air plenums are identified above with a or b for driver side and passenger side, respectively. In this embodiment, a first flow (AAA1) intended for the driver side second and third rows (depicted in the figures) and a second flow (now shown, but AAA2 with reference to the distributor duct 500, discussed below) intended for the passenger side second and third rows (similar to the figures).

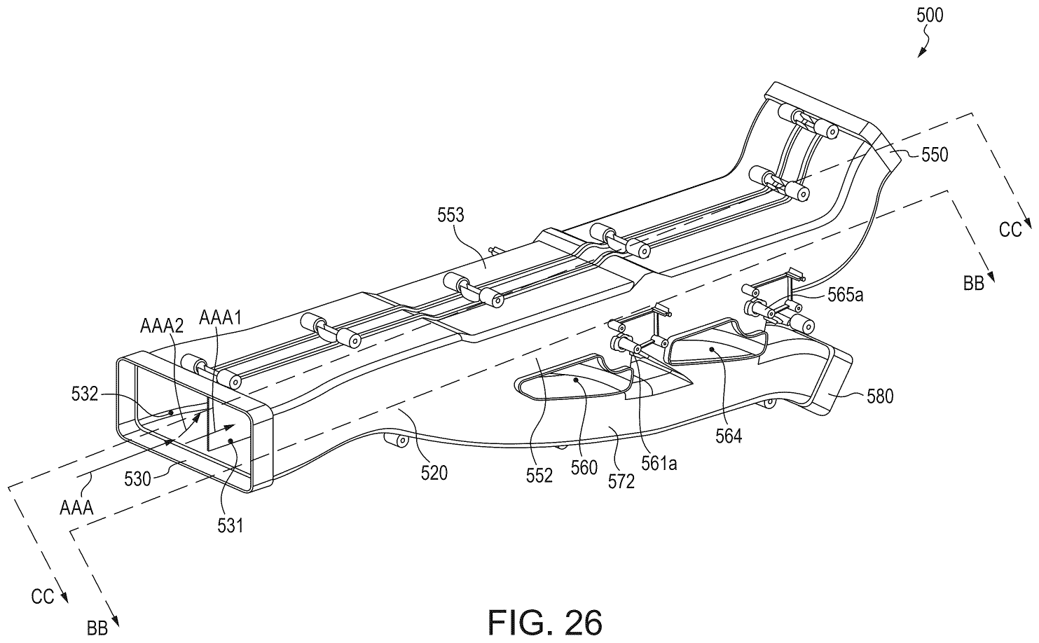

A distributor duct 500 is provided in FIGS. 26-31. The distributor duct 500 is configured to receive air from the air conditioning housing 400, and specifically air that flows from the rear outlet 498 of the air conditioning housing 400. Distributor duct can be adapted to provide comfort level to each rear passenger in different vehicle configurations. The number of outlets, doors, and internal splitters would be modified accordingly. In FIG. 26, the air flow entering the distributor duct 500 is depicted schematically as AAA. In an embodiment, as discussed above, wherein the air conditioning housing 400 has two rear outlets 498, one for the driver side of the vehicle and one for the passenger side of the vehicle, the air that flows into the distributor duct 500 is AAA1 for the driver side and AAA2 for the passenger side, which are both depicted in FIG. 26. In other embodiments, the rear outlet 498 of the air conditioning housing 400 may include only a single air flow, and in that case, the single air flow AAA is received within the inlet 530 and is split into two separated flows AAA1 and AAA2 by an internal wall 533.

The distributor duct 500 is arranged to provide air flow to several different vents throughout the vehicle, and specifically vents in the second row of the vehicle and air that flows to the third row either directly to vents or to the air flow selection system 600 as discussed below. In an alternate embodiment, the air that flows to the third row can flow into a modified distributor duct that includes a structure operationally and/or physically similar to the first plenum 552/553, discussed below.

In some embodiments, the distributor duct selectively allows air flow to the driver and passenger side second row floor vents (typically hot air), the driver and passenger side pillar column vents, and to a second row center console. The air flow to each of these various outlets is controlled by the HVAC controller 1000, which operates the valves (via operators, discussed below) to control the desired air flow. The distributor duct 500 is configured for the driver and passenger side air flows to be controlled independently of each other.

The distributor duct includes a first path 552, 553 and a second path 572, 573. The first path (element 552) and the second path (element 572) that are configured to send air to the driver side of a vehicle (for driving on the right side of the road as in North America or Germany), and the first path (element 553) and the second path (573) are configured to send air to the passenger side of the vehicle (for driving on the right side of the road as in North America or Germany). For the sake of brevity, only the components for the driver side of the vehicle will be described herein, and the components for the passenger side operate as described with respect to the driver side unless specifically described herein. In some embodiments, the first paths (552, 553) are disposed vertically above the second paths (572, 573) when the distributor duct 500 is installed as desired within a vehicle that receives the HVAC system. In other embodiments, the first paths (552, 553) are disposed such that a majority of the first paths 552, 553 are vertically above the second paths (572, 573) when the distributor duct is installed as desired within a vehicle. The distributor duct 500 may be installed within or below the center console between the driver seat and passenger seat in the front row of the vehicle.

The inlet 530 (driver inlet 531) receives air from the air conditioning housing 400, which has been treated as desired with temperature control by the HVAC controller 1000 within the air conditioning housing 3400 as well as air flow rate via fan speed. The air AAA1 flows into a divergence 538 that directs air both to the first path 552 (GGG1, schematic) and the second path 572 (CCC1, schematic).

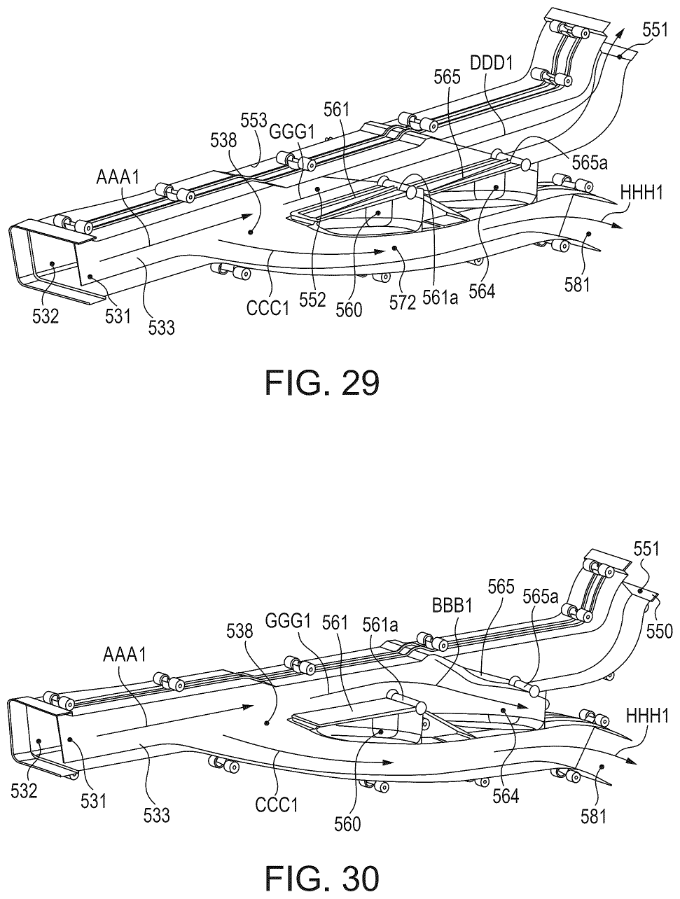

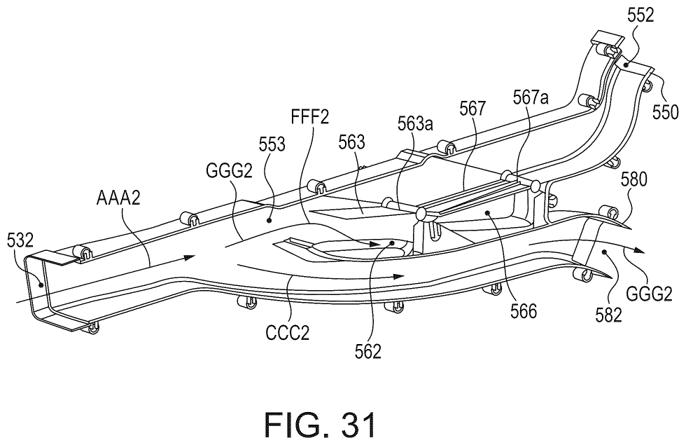

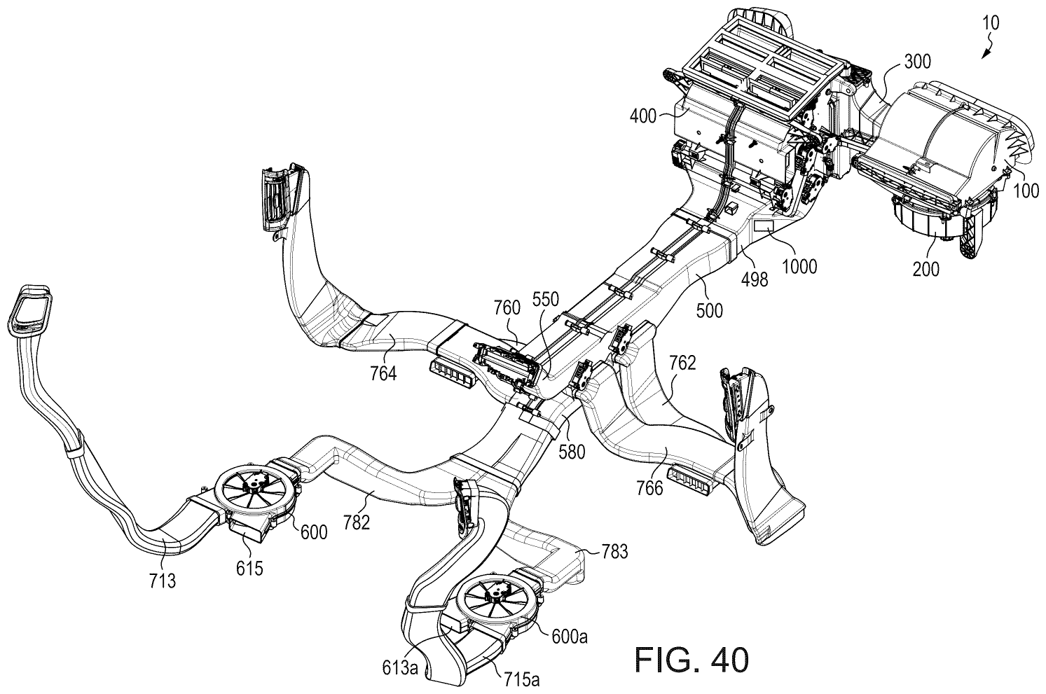

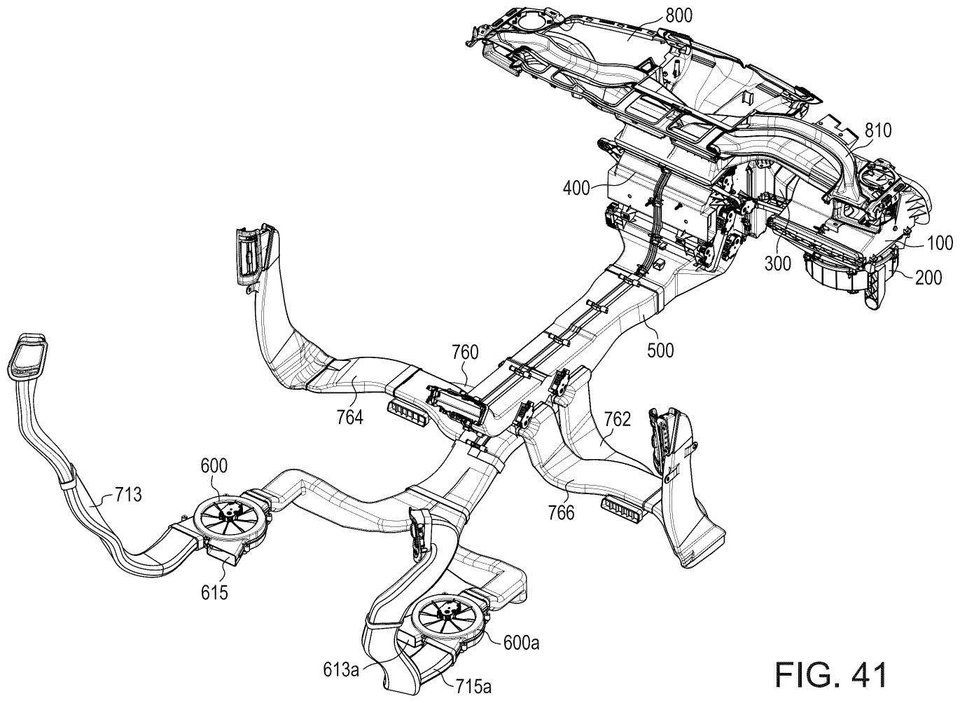

In some embodiments first path 552 has two doors 561, 565 that are placed in series (FIGS. 29, 30. The first path to the passenger side 553 also may have two doors in series 563, 567 that operate similar to the doors 561, 565, discussed herein. The first path 552 includes a first door 561 that can be opened (similar to FIG. 31, which shows the first door 563 (for the passenger side) in the open position) to allow air flow to out the exit 560 (flow FFF1, similar to FFF2 of FIG. 31) that leads to a flow path 760 (FIGS. 40, 41, similar passenger side flow path is 762) to the driver side floor vent (typically for hot air) within the second row of the vehicle. The first door 561 can be shut (like FIGS. 29, 30) that prevents air flow to the exit 560. The term “prevent” herein is defined similarly to prevent in other portions of this specification.

The second door 565 is provided downstream of the first door 561 (as the air flows GGG1 through the first path 552) and either prevents or allows air flow to the exit 564. The exit 564 leads to a flow path 764 (FIGS. 40, 41, similar passenger side flow path is 766) to a driver side pillar vent, which typically provides air flow to a passenger in the second row driver side of the vehicle. When the second door 565 is open (FIG. 30) air flows (air flow BBB1, FIG. 30, schematic) through a flow path 764 that leads to the side pillar vent, and when the second door 565 is shut (FIG. 29) air is prevented from flowing to the exit 764, and allowed to flow to the second console exit 551 (flow DDD1, FIG. DD). In some embodiments, the first valve 561 can be between the open and shut positions, to allow some flow to the exit 560 (FFF1) and some flow past the first door 561, either to the exit 564 or to the outlet 551. In some embodiments, the second valve 565 can also be between the open and shut positions to allow flow to both the exit 564 (BBB1, schematic) and to the exit 551 (DDD1) schematic.

The second path 572 allows flow (AAA1) that entered the distributor duct 500 to flow from the divergence 538 to the second outlet 581 (flow HHH1, schematic). In some embodiments, not shown, a door may be provided within the second flow path 572 to selectively isolate or allow flow therethrough.

The doors 561, 563, 565, 567 may be controlled by operators now shown—but similar to operators described for other valves herein, with the operators causing a respective shaft (e.g. shaft 561a for door 561) to a position as directed by the HVAC controller 1000.

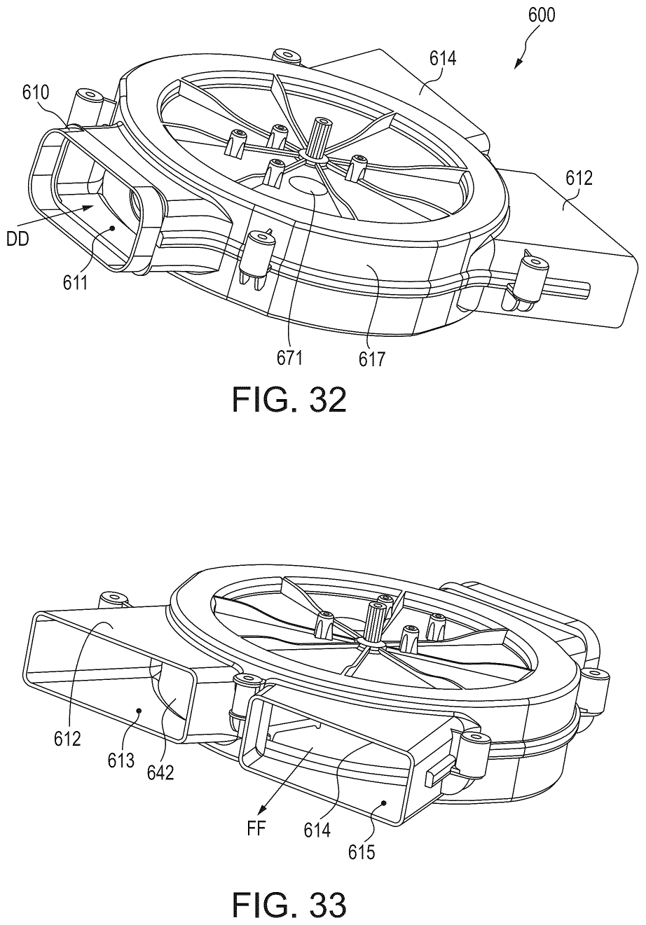

Turning now to FIGS. 32-39(E), an air flow selection system 600 for an HVAC system is provided. The air flow selection system 600 is depicted in FIGS. 40-41 as receiving air flow from the rear distributor duct 500, and is provided to direct air that flows to the third row of a vehicle. In other embodiments, the air flow selection system 600 may be connected to the rear outlet 498 of the heat treatment housing 400 to determine where air flows to in the second row of a vehicle. The air flow selection system 600 may be controlled by the HVAC controller 1000 (FIG. 40) (schematic) to cause the air that reaches the inlet 610 to be directed to the appropriate outlet, or to prevent any flow through the air flow selection system 600, as discussed herein. In some embodiments, the system includes a first trunk 782 that leads from the driver side lower aperture 581, and a second trunk 783 that leads from the passenger side lower aperture 582. In this embodiment two separate air flow selection systems 600, 600a (FIG. 40) may be provided. Both air flow selection systems 600, 600a are constructed the same manner and operated by the HVAC controller 1000 in the same manner, and for the sake of brevity only the driver side air flow selection system 600 is described below, with any differences between the driver and passenger side systems discussed below.

The air flow selection system 600 includes a housing 620 that includes an air inlet 610 that forms an air inlet aperture 611, and first and second outlets 612, 614 that form respective air outlet apertures 613, 615.

In embodiments, with driver and passenger side air flow selection systems 600, 600a each include outlets 612, 614 (612a, 612b for the passenger side system 600a). In the driver side system 600, the first outlet 612 may be connected to a flow tube 713 that leads to a pillar that directs air to the third row driver side, and the second outlet 614 may be connected directly with a vent that directs air to the third row driver side, such as a floor vent. In other embodiments, a flow tube (not shown) may be provided to allow flow to a third row center console, or in some embodiments from the back of a second row seat. The passenger side system 600a may be arranged such that the first outlet 612a may have a flow path like the second outlet 614, and the second outlet 614a of the second system may have flow to a tube 715a that directs air to a pillar that directs air to a third row passenger side.

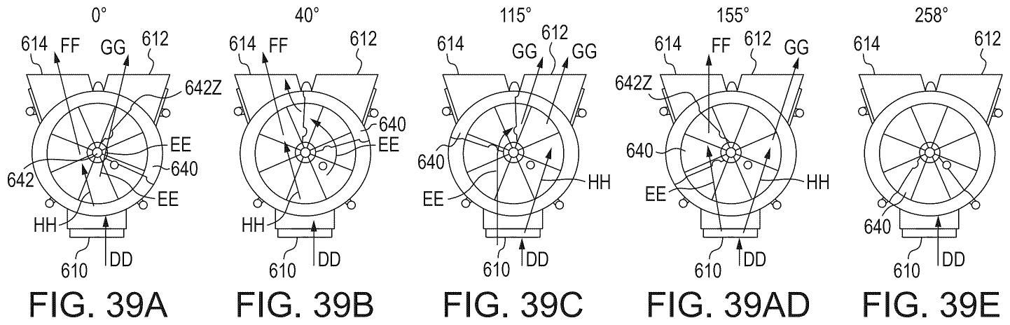

The housing 620 includes a valve 640 that moves in a circular fashion within the housing 620 to selectively block one of the inlet aperture, or the first and second outlet apertures 613, 615, or to allow flow through all three apertures. The various positions of the valve 640 within the housing are depicted in FIGs. XA to XE, and are discussed herein. In FIG. 39A the valve 640 is positioned to allow flow through all three apertures (611, 613, and 615) with flow through the inlet aperture 611 depicted schematically as DD, flow through the first outlet aperture 613 depicted schematically as GG, and the flow through the second outlet aperture 615 depicted schematically as FF Depending upon the size of the face of the valve 642 (discussed below) and the size of the three apertures 611, 613, and 615, in the first position (FIG. 39A) the valve face 642 may be completely outside of the first outlet aperture 613. In the embodiment depicted in the figures, the size of the inlet and outlet apertures 611, 613, 615 is maximized such that an edge portion 642z of the valve face 642 extends across and end portion of the first outlet 613. In this position, the valve only blocks a small portion of the total area of the first outlet 613 and does not cause a substantial resistance to air flow GG from the first outlet aperture 613.

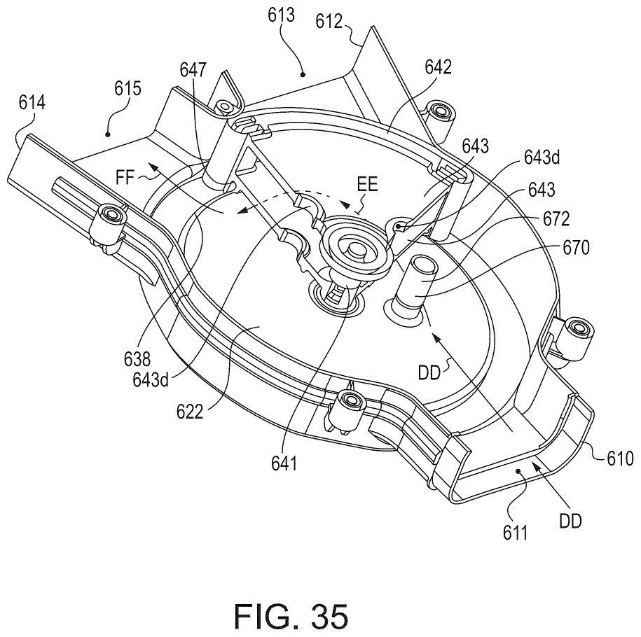

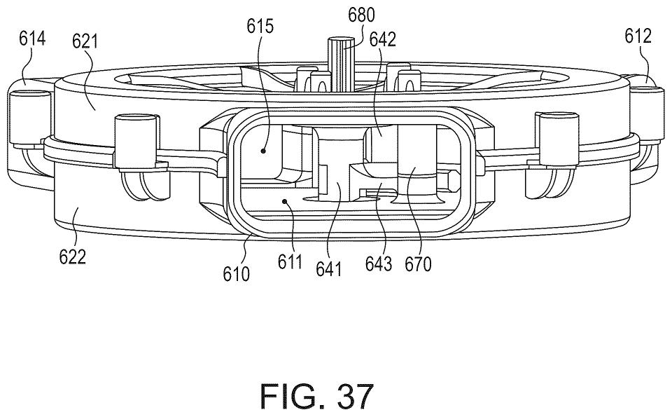

In a second position FIG. 39B the valve 640 is positioned such that the valve face 642 completely blocks the first outlet aperture 613. Flow through the housing inlet 611 is allowed (schematically depicted as flow DD) and flow out of the second outlet 615 is allowed (schematically depicted as flow FF). As depicted in FIG. 37 (and also FIG. 35), the valve 640 is constructed with a radial rib 643 that extends from the valve torque input 641 to the valve face 642, with a portion of the air flowing into the housing from the inlet (DD, schematic) being able to flow past the radial rib 643 (either over, under, or between in embodiments when there are two separated radial ribs 643) (air flow EE, schematic) and through the outlet aperture 613 or 615 that is not blocked by the valve faced 642. This ability provides a very large flow area for air through the housing, which minimizes an flow restriction caused by the air flow selection system 600, which increases the air flow rate out of the outlet vents (i.e. the floor vent, or a center console vent, or pillar vents), and minimizes any extra noise or vibration created by turbulent flow through the housing 620. Similarly, because the housing 620 provides very minimal flow restriction, the overall fan HVAC fan 210 speed may be limited due to this feature (and several other inventive features of the HVAC system discussed herein), which minimizes noise and vibration from the overall HVAC operation, and limits the current used by the fan 210 during operation to minimize the degradation of the range of an electric vehicle that includes the HVAC system (and the inventive air flow selection system 600 discussed herein.

In the third position (FIG. 39C), the valve is positioned to block flow through the second outlet aperture 615, but allow flow through the first outlet aperture (GG, schematic). As with the second position XB, air can flow across the radial rib (EE) toward the first outlet 613, as well as air that does not pass by the radial rib 643 (flow HH).

In the fourth position (FIG. 39D), the valve 640 is positioned to allow flow through the air inlet 611 (flow DD) and out of both the first and second outlet apertures 613, 615 (flows GG, and FF). As with the first position, in this embodiment, an edge portion 642z of the valve face 642 extends over the second air outlet aperture 615, but this blocks only a small portion of the second air outlet aperture 615 and does not cause a substantial resistance to air flow FF through the second outlet aperture 615.

In the fifth position (FIG. 39E), the valve 640 is aligned to block flow into the housing 620 through the inlet aperture 611. In other embodiments, the housing 620 may be laid out differently, i.e. with the inlet and outlets at different positions within the housing such that the different functional positions of the valve 640 (discussed above) may be reached in a different order. It is preferred that the inlet aperture 611 be positioned on a substantial opposite side of the housing 620 from the outlet apertures 613, 615 such that the air that flows into the housing through inlet aperture (flow DD, schematic) flows toward the first and second outlets 613, 615 (when not blocked by the valve 640 as discussed below) in relatively straight lines (HH, EE) to minimize the flow restrictions and turbulent air flow within the housing 620, which could create noise and vibrations and provide resistance to air flow through the housing 620.

In a preferred embodiment, the width of the inlet opening 611 is the same (or about the same as the radius of the circle 652 (i.e. between the center of the housing and the side wall 617 of the housing (either the radius of the circle, or the larger radius of the side wall 617 at sections QQ as discussed herein. In some embodiments, the cross-sectional area of the first and second air outlets 613, 615 are the same. In some embodiments, the cross-sectional area of the first and second air outlets 613, 615 are larger than the cross-sectional area of the air inlet 611. In some embodiments, the cross-sectional area allowing flow through the outlet 613, 615 when an edge portion 642z of the valve is aligned with an edge of the respective air outlet (i.e. FIG. 39A air outlet 613, FIG. 39C air outlet 615) the open portion of the partially blocked air outlet is the same or larger than the cross-sectional area of the air inlet 611.

The housing 620 may be formed with a top member 621 and a bottom member 622 that mate together to establish the internal volume 623, through which the inlet aperture 611 and the first and second outlet apertures 613, 615 communicate. The top member 621 and the bottom member 622 may each include a portion of the air inlet 610 and the first and second outlets 612, 614, or in other embodiments, the inlet and the outlets 612, 614 may be separate structures that extend out of the top and bottom members 621, 622. The top and bottom members 621, 622 are formed with voids that establish the inlet aperture 611 and the first and second outlet apertures 613, 615.

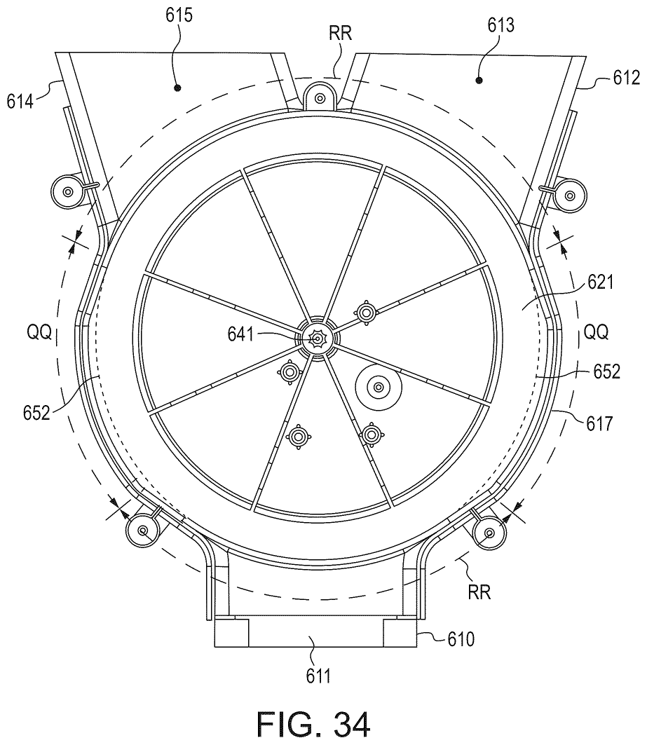

A top view of the housing 620 and the specifically the top member 621 is depicted in FIG. 34. The housing 620 (and therefore the top and bottom members 621, 622) may be circular, or in the embodiment depicted in the figures substantially circular. Specifically, the housing 620 may be constructed such that the inner surface of the side walls 617 may be arranged along a circle (652) along the portions (RR, FIG. 34) that include the inlet aperture 611 and the first and second outlet apertures 613, 615) and the side walls 617 are arranged with a curvature (which may be a constant curvature) that has a radius that is larger than the radius of the circle 652, as depicted with the side wall along positions QQ having a larger radius than the circle 652 depicted with dotted lines along portions QQ.

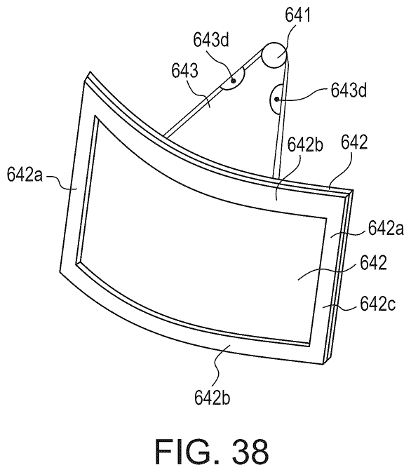

The valve is depicted in FIG. 38. The valve has a valve face 642 that extends from the radial rib 643. The valve face 642 has a curve such that radially outward facing face of the valve face 642 has a constant radius that is slightly less than the radius of the circle 652. The valve face 642 has an area that is larger than each of the inlet aperture 611 (specifically a curved length that is greater than a curved length of each aperture 611, 613, 615), so that when the valve face 642 is aligned with one of the apertures, it completely or substantially blocks air flow through the respective aperture that the valve face 642 is aligned with, to prevent flow therethrough. The term prevent is defined herein to result in either no air flowing past the valve face and through the aligned aperture but also including a possible di minimus flow past due to imperfect alignment or imperfect sizing of the components, or wear of the components. When used to describe other components within the specification the term prevents is similar, i.e. includes not allowing the action that is prevented but potentially allowing some di minimius action (e.g. air flow) such as due to imperfect contact between components, or due to manufacturing tolerances or wear of components.

In some embodiments, the valve face 642 includes an elongate compressible member 642a (such as a compressible foam or a rubber) that is disposed about some or all of the outer edges portions of the radial outward facing surface of the valve face 642. As depicted in FIG. 38 the compressible member 642a may be disposed along the top and bottom surfaces (642b) and the right and left surfaces 642c, while in some embodiments it may only be on the top and bottom surfaces 642b (and not the right and left surfaces), while in other embodiments it may be on the right and left surfaces 642c and not the top and bottom surfaces 642b.

The compressible member 642a extends from the valve face 642 such that the combined radius of the outer surface of the valve face 642 and the compressible member 642a is slightly larger than the radius 652 of the circle. Accordingly, when the valve 642 is aligned to block one of the apertures (611, 613, 615) the compressible layer contacts the side wall 617 of the housing that surrounds the aligned aperture, and compresses the compressible layer slightly. This contact between the side wall 617 of the housing 620 and the compressible member 642a prevents air flowing pas the valve and through the blocked air aperture. The compression of the compressible member 642a is relatively minor such that this compression does not create significant friction between the valve face 642 and the side wall 617 of the housing 620 that would result in significant resistance to rotating the valve 640 with respect to the housing between the various positions depicted in FIGS. 39A-39E.

In embodiments where the radius of the housing 620 away from the air apertures 611, 613, 615 is larger than the circle 652, the combined radius of the outer surface of the valve face 642 and the compressible member 642a is less than the radius of the inner wall in regions QQ, such that the valve face 642 does not contact the side wall of the housing 620 in regions QQ (i.e. when the valve 640 is not positioned to block flow through any of the air flow apertures.

In some embodiments, the compressible member 642a is compressed within a range of about 5% to 25% of the overall thickness of the compressible member 642a, including all compression percentages within this range, such as about 8%, 10%, 12%, 14%, 16%, 18%, 20%, and 22%.

In a preferred embodiment, the valve face 642 and the compressible layer 642a are sized such that when the valve face 642 is aligned to block a specific air aperture (611, 613, 615) the compressible layer is disposed entirely outboard of the cross-section of the aligned aperture, such that the entire compressible layer 642a contacts the side wall 617 of housing 620. In some embodiments, the air flow apertures 611, 613, 615 may have a height that is just slightly less than a height of the valve face 642 within top and bottom compressible layers 642b, such that the top and bottom compressible layers 642b constantly contact the side wall 617 of the housing 620. In a preferred embodiment depicted in FIG. 35, one or both of the top and bottom housing pieces 621, 622 may include a circular track 638, which may be a ridge, or a transition from a raised surface that travels all of the way to the center of the housing and forms an edge that faces radially outward (as depicted in FIG. 35). The radial rib 643 (or the door face 642) includes a foot portion 647 that rides along one or more surfaces of the circular track 638 to stabilize the circular motion of the valve 640 within the housing 620. In some embodiments, the circular track 638 and/or the foot portion 647 may be formed from a low friction material for low resistance sliding between the two as the valve moves between rotational positions. In an embodiment, the door portion may include a bearing (not shown) that rides upon the circular track 638 to eliminate the higher friction due to sliding.

The position of the valve 640 within the housing 600 is controlled by the HVAC controller 1000, which operates the various components of the HVAC system to achieve the desired air flows and temperature control within the passenger compartment, either automatically or manually based upon passenger inputs to the HVAC input unit (either on the dashboard, or in embodiments where local control is possible through an HVAC input that is accessible by the second or third row passengers). The HVAC controller 1000 causes the valve 640 to be positioned to allow the air flow that enters the housing 620 to flow to the desired outlet (i.e. a console vent, a floor vent, a post vent, and the like). The HVAC controller 1000 may cause the valve operation by sending a signal for the desired valve position to a valve operator 645 that can cause rotation of the valve shaft 641. The valve operator 645 (schematic, similar to other HVAC valve/door operators depicted in the figures and discussed herein) causes the valve shaft 641 to rotate within the housing (aligned at the center of the housing 620 so that the valve face moves along a path just inwardly of the circle 652, as discussed above). The operator 645 may measure or monitor the rotational position of the valve shaft 641 with various systems as known in the art, such as an encoder, or with a visual sensor, or with a mechanical structures on the shaft that physically interact with corresponding features on the sensor when the shaft is in specific positions.

In some embodiments the housing 620 may include a mechanical stop 670 that is mechanically contacted by the radial rib 643 when in one or both of the extreme positions along the travel of the valve 640 within the housing. With reference to FIG. 39A, when the valve is in the first position (allowing flow through all three apertures) the radial rib contacts the mechanical stop 670 on a first side of the radial rib 643. This mechanical contact may be sensed by the operator 645 to determine that the valve is in the first position (FIG. 39A) (and therefore no further torque upon the shaft 641 should be applied). In some embodiments, the opposite side of the radial rib 643 may contact the mechanical stop 670 when the valve is in the fifth position (FIG. 39E), which is the position where the input aperture 611 is blocked by the valve face 642.

In some embodiments, the geometry of the radial rib 643 may include a cutout 643d that allows the mechanical stop 670 to extend therein when in the respective first or fifth position, which allows the radial rib 643 to be made larger than it could be without the cutout 643d but still allow the full desired range of motion.

The term “about” is specifically defined herein to include a range that includes the reference value and plus or minus 5% of the reference value. The term “substantially the same” is when the item under comparison is within 5% of the aspect of the reference value of the item. The term “substantially” is when the referenced value or referenced aspect is within 5% of the reference value. For example, if the referenced item is an angle, something is substantially at that angle if it is within plus or minus 5% of the angle. The term “substantially” referenced with respect to a state (e.g. a path being substantially blocked) means that referenced state is blocked but may allow for di minimus flow therepast. The term “substantially” is when the term under comparison is not the exact same item (such as shape or length) as mentioned but with only di minimus changes from the referenced item as those di minimus changes would be appreciated by one or ordinary skill in the art, such as changes that do not significantly affect the structure of function of the item.

The computing elements or functions disclosed herein (such as the HVAC controller 1000) may include a processor and a memory storing computer-readable instructions executable by the processor. In some embodiments, the processor is a hardware processor configured to perform a predefined set of basic operations in response to receiving a corresponding basic instruction selected from a predefined native instruction set of codes. Each of the modules defined herein may include a corresponding set of machine codes selected from the native instruction set, and which may be stored in the memory. Embodiments can be implemented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, optical disc, memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described embodiments can also be stored on the machine-readable medium. Software running from the machine-readable medium can interface with circuitry to perform the described tasks. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Naturally, in view of the teachings and disclosures herein, persons having ordinary skill in the art may appreciate that alternate designs and/or embodiments of the invention may be possible (e.g., with substitution of one or more components for others, with alternate configurations of components, etc.). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

Representative Paragraph 1: An air mixing damper system, further comprising:
a first rotatable door that rotates about a first shaft that extends along a first axis;
a second rotatable door that rotates about a second shaft, the second shaft disposed along a second axis, the second axis is collinear with the first axis;
the first door is rotatable about the first axis and the second door is rotatable about the second axis;
a first actuator operatively engaged with the first shaft;
a second actuator operatively engaged with the second shaft, wherein the first and second doors are each capable of rotating independently of the other of the first and second doors.

Representative Paragraph 2. The air mixing damper system of Representative Paragraph 1, wherein the first actuator and the second actuator each operate such that the respective first and second doors can independently be moved between an open configuration and a closed configuration and can each be independently maintained in the closed and open positions.

Representative Paragraph 3: The air mixing damper system of Representative Paragraph 2, wherein the first actuator operates such that the first door can be positioned in a plurality of intermediate positions between the open configuration and closed configuration.

Representative Paragraph 4: The air mixing damper system of either one of Representative Paragraphs 2 or 3, wherein the second actuator operates such that the second door can be positioned in a plurality of intermediate positions between the open configuration and the closed configuration.

Representative Paragraph 5: The air mixing damper system of any one of Representative Paragraphs 1-4, wherein the first actuator provides torque along a third axis that is parallel the first axis but is offset from the first axis, and the second actuator provides torque along the second axis.

Representative Paragraph 6: The air mixing damper system of Representative Paragraph 5, wherein further comprising an input gear that is constrained with the first actuator and an output gear, wherein the input gear rotates about the third axis and the output gear is meshed with the input gear and rotates about the first axis.

Representative Paragraph 7: The air mixing damper system of any one of the preceding Representative Paragraphs, further comprising an inner shaft that extends coaxially within the first and second shafts, wherein the inner shaft receives torque from the second actuator and transfers torque to the second shaft.

Representative Paragraph 8: The air mixing damper system of any one of Representative Paragraphs 1-6, wherein the first and second shafts are arranged adjacent to each other, wherein first door extends radially from the first shaft and the second door extends radially from the second shaft.

Representative Paragraph 9: The air mixing damper of Representative Paragraph 8, wherein the first door bridges outside of and across the second shaft, and wherein the second door bridges outside of and across first shaft.

Representative Paragraph 10: The air mixing damper system of Representative Paragraph 9, wherein the first and second shafts are arranged like opposing cylindrical portions of a conventional door hinge, further comprising an inner shaft that extends coaxially within the first and second shaft, wherein the inner shaft is arranged like a pin of the conventional door hinge.

Representative Paragraph 11: The air mixing damper system of Representative Paragraph 10, wherein the inner shaft receives torque from the second actuator and transfers torque to the second shaft.

Representative Paragraph 12: The air mixing damper system of Representative Paragraph 11, wherein the inner shaft includes a plurality of radially extending lobes along a portion of a length of the inner shaft, wherein the second shaft includes a plurality of cutouts that each received a lobe of the plurality of radially extending lobes therein to transfer torque from the inner shaft to the second shaft.

Representative Paragraph 13: The air mixing damper system of any one of Representative Paragraphs 8-12, wherein the first door is fixed to the first shaft and the second door is fixed to the second shaft.

Representative Paragraph 14: The air mixing damper system of any one of Representative Paragraphs 1-13, wherein one or both of the first and second doors have one or more longitudinal ribs that extend from a planar face of the respective door.

Representative Paragraph 15: The air mixing damper system of Representative Paragraph 14, wherein the one or more longitudinal ribs are a plurality of ribs that extend an acute angle from a line that extends perpendicular to the first axis.

Representative Paragraph 16: The air mixing damper system of Representative Paragraph 15, each of the plurality of ribs within one of the first or second doors extend at different acute angles from each of the other ribs upon the same of the first or second door.

Representative Paragraph 17: The air mixing damper system of any one of Representative Paragraphs 1-16, wherein outer perimeter edge of both of the first and second doors includes an elastomeric material in positions where contact is made between the respective perimeter edge of the door and fixed surfaces within a housing the rotatably receives the door.

Representative Paragraph 18: An air circulation assembly, comprising the air mixing damper system of any one of Representative Paragraphs 1-17,
wherein the first and second actuators and the first and second shafts are supported by a housing, wherein the housing is configured to be connected to a source of relatively cold air and a source of relatively hot air, wherein the housing establishes a mixing space therein, and the housing is further configured to be connected to selectively and independently allow air flow from the mixing space to a plurality of air outlets within a vehicle, and further comprising a controller, wherein the controller causes operation of the first actuator to cause the first door to be positioned with respect to the source of relatively hot air to selectively allow or prevent a flow of relatively hot air from the source of relatively hot air into the mixing space, and the controller causes operation of the second actuator to cause the second door to be positioned with respect to the source of relatively cold air to selectively allow or prevent a flow of relatively cold air from the source of relatively cold air to the mixing space.

Representative Paragraph 19: The air circulation assembly of Representative Paragraph 18, wherein the controller is configured to operate the first actuator to cause the first door to be positioned with respect to the source of relatively hot air to a throttled position to allow an amount of relatively hot air into the mixing space that is less than an amount of relatively hot air that could flow to the mixing space if the first door was in a fully opened configuration, and the controller is configured to operate the second actuator to cause the second door to be positioned with respect to the source of relatively cold air to a throttled position to allow an amount of relatively cold air into the mixing space that is less than amount of relatively cold air that could flow to the mixing space if the second door was in a fully opened configuration.

Representative Paragraph 20: The air circulation assembly of Representative Paragraph 19, wherein the housing comprises a plurality of auxiliary valves that are independently operated by the controller, wherein each auxiliary valve when in an open position allows air flow from the mixing space to a specific air outlet within the vehicle that is associated with the auxiliary valve, wherein each auxiliary valve is operated by the controller between an open position and a closed position.

Representative Paragraph 21: The air circulation assembly of Representative Paragraph 20, wherein each of the plurality of auxiliary valves are positioned in either the open position or in a closed position that prevents air flow from the mixing space to the specific air outlet within the vehicle that is associated with the auxiliary valve.

Representative Paragraph 22: The air circulation assembly of Representative Paragraph 20, wherein the specific air outlets within the vehicle includes a front windshield defrost system, a side window defrost system, a vent panel air flow system, and a front row floor ventilation system.

Representative Paragraph 23: The air circulation assembly of any one of Representative Paragraphs 18-22, wherein the housing includes a flow path that selectively allows or prevents air flow from the source of relatively hot air and from the source of relatively cold air to flow to a remote environment within a vehicle, wherein the air that flows into the flow path to the remote environment does not interact with the first and second doors.

Representative Paragraph 24: The air circulation assembly of any one of Representative Paragraphs 18-23, wherein the housing comprises first and second air mixing damper systems that each are positioned upstream of respective first and second mixing spaces, wherein the controller independently controls the first and second actuators associated with each of the first and second air mixing damper systems, wherein a portion of the air flowing from the air mixing space associated with the first air mixing damper system is configured to be directed to a vent panel air flow system and/or a front row floor ventilation system proximate to a driver's seat area of a vehicle, and a portion of the air flowing from the air mixing space associated with the second air mixing damper system is configured to be directed to a vent panel air flow system and/or a front row floor ventilation system proximate to a front passenger's seat area of a vehicle.

Representative Paragraph 25: The air circulation assembly of any one of Representative Paragraphs 18-23, wherein the housing further comprises a first mechanical stop that is disposed proximate to the first actuator, wherein the first mechanical stop is positioned to directly limit a range of rotation of a first component that directly receives torque from the first actuator; and
the housing further comprises a second mechanical stop that is disposed proximate to the second actuator, wherein the second mechanical stop is positioned to interact with a leg that extends radially from a fourth shaft that directly receives torque from the second actuator and is rotatably fixed to the second shaft.

Representative Paragraph 26: An HVAC system for a vehicle, comprising:
an air intake housing that includes an air inlet and an air outlet, the air inlet comprising a first inlet that is aligned to receive air flowing from a passenger compartment of a vehicle that includes the housing, and a second inlet that is configured to receive air from outside of a vehicle;
wherein the air outlet receives air from the first and second inlets and allows the air from the first and second inlets to flow to a fan housing that is connected to an air outlet of the air intake housing;
the housing further comprising a valve disposed within the housing that is positionable in a first position to allow air flow from the first air inlet to the air outlet and prevent flow from the second inlet to reach the air outlet, is positionable in a second position that allows air flow from the second inlet to flow to the air outlet and prevents air flow from the first air inlet to reach the air outlet,
air intake housing comprises a first space for receiving a filter, wherein when the filter is installed within the first space, the air that is allowed by the valve to flow to the air outlet flows through the filter before reaching the air outlet, wherein the housing further comprises a second space disposed between the first space and the air outlet, such that air that flows through the filter when installed flows through the second space before reaching the air outlet.

Representative Paragraph 27: The HVAC system of Representative Paragraph 26, wherein the second space is wider than the first space.

Representative Paragraph 28: The HVAC system of Representative Paragraph 27, wherein an inlet portion of the second space is adjacent to the first space and adjacent to a filter outlet when the filter is installed within the first space, wherein the inlet portion of the second space the same cross-sectional geometry as an outlet of the first space within which the filter outlet extends when the filter is installed, wherein the second space transitions in cross-section along the second space until reaching the air outlet which is at an outlet portion of the second space, wherein the air outlet is circular.

Representative Paragraph 29: The HVAC system of Representative Paragraphs 26-28, further comprising the structure in any one or more of Representative Paragraphs 1-25.

Representative Paragraph 30: An HVAC system for a vehicle, comprising:
an air inlet housing that supports a fan housing, and a fan that is rotatably mounted within the fan housing, wherein air from the air inlet housing flows directly to a suction of the fan, and when the fan is rotating about its rotational axis air is expelled out of the fan radially away from the rotational axis;
a scroll that receives the expelled air from the fan when the fan rotates within the fan housing, wherein the scroll transitions from the fan housing to a pathway that leads to an air conditioning housing, the air conditioning housing includes an evaporator of a heat pump or refrigeration system associated with a vehicle, the scroll extends around the fan to direct air expelled from the fan to an exit of the scroll that transitions to an inlet into the pathway;
wherein the pathway includes the inlet and transitions to an outlet that is proximate to an evaporator within an air conditioning housing, wherein a cross-sectional area of the pathway increases as the pathway extends from the inlet to the outlet.

Representative Paragraph 31: The HVAC system for a vehicle of Representative Paragraph 30, wherein the evaporator has a height, and wherein a first percentage of air that flows though the evaporator is configured to flow through a plurality of air conditioning housing outlets that flow to a first row of the vehicle, and a remaining percentage of air that flows through the evaporator is configured to flow through a rear outlet of the air conditioning housing and toward a rear row of a vehicle, wherein the air that flows past a first percentage of a height of the evaporator that is measured downwardly along the evaporator for a distance that is the first percentage of the total height is directed to the first row of the vehicle, and the remaining distance two a bottom of the evaporator is the remaining percentage of the total height,
wherein the cross-sectional area of the pathway along its length increases along its length with a top of the pathway being planar and aligned at a first acute angle with respect to an axis that is perpendicular to a plane that extends through the exit of the scroll, and a bottom of the pathway being planar and aligned at a second acute angle with respect to the axis, wherein the first acute angle is larger than the second acute angle.

Representative Paragraph 32: The HVAC system for a vehicle of one of Representative Paragraphs 30 or 31, wherein a height of the pathway outlet is substantially the same as the height of the evaporator, wherein a difference in height of the pathway outlet and the pathway inlet is equal to the tangent of the first acute angle plus the second acute angled multiplied by a distance between the pathway inlet and the pathway outlet.

Representative Paragraph 33: The HVAC system for a vehicle of any one of Representative Paragraphs 30-32, wherein the first acute angle is within a range of 10 to 20 degrees, and preferably within a range of about 12-15 degrees, and the second acute angle is within the range of about 3 to 15 degrees, and preferably within a range of about 4-7 degrees.

Representative Paragraph 34: The HVAC system for a vehicle of any one of Representative Paragraphs 30-33, wherein the cross-sectional area of the pathway outlet is larger than the pathway inlet by about 1.75 to 3.5 times the cross-sectional area of the pathway inlet.

Representative Paragraph 35: The HVAC system for a vehicle of Representative Paragraph 34, wherein a width of the pathway is a dimension that is perpendicular to a length of the pathway that extends between the inlet and the outlet and also perpendicular to the rotational axis of the fan, wherein the width of the pathway is about constant along an overwhelming majority of the length of the pathway, or the width of the pathway increases along a portion or an overwhelming majority of the length of the pathway.

Representative Paragraph 36: The HVAC system for a vehicle of any one of Representative Paragraphs 34-35, wherein a plane extends through the passageway, wherein the first percentage of the air that flows into the evaporator and ultimately flows to the first row of the vehicle flows along the passageway above the plane and most of the remaining percentage of air that flows through the evaporator and flows through the rear outlet flows below the plane, wherein a distance from the plane to the top of the pathway at the outlet divided by a distance from the plane to the top of the pathway at the inlet is within the range of 1.75 to 2.5.

Representative Paragraph 37: The HVAC system for a vehicle of Representative Paragraph 36, wherein a distance from the plane to the bottom of the pathway at the outlet divided by a distance from the plane to the bottom of the pathway at the inlet is within the range of 1.5 to 2.25.

Representative Paragraph 38: The HVAC system for a vehicle of any one of Representative Paragraphs 36 or 37, wherein the plane extends from the pathway inlet at a vertical location that is below a midpoint of a height of the fan, approximately proportional to the ratio of airflow splits between the front and rear.

Representative Paragraph 39: The HVAC system for a vehicle of any one of Representative Paragraphs 30-38, wherein the top of the pathway includes a rapidly increasing height portion that is downstream of the planar portion, wherein an entire length rapidly increasing portion is closely proximate to the outlet of the pathway, and
wherein the bottom of the pathway includes a rapidly decreasing height portion that is downstream of the planar portion, wherein an entire length of the rapidly decreasing height portion is closely proximate to the outlet of the pathway.

Representative Paragraph 40: The HVAC system of any one of Representative Paragraphs 30-39, wherein the fan comprises an upper ring and a plurality of fan blades that are arranged about a circumference of the fan, wherein each of the plurality of fan blades are fixed to the upper ring, such that the upper ring mechanically supports each fan blade, wherein a height of the upper ring is between about 10% and 20% of a total height of the fan, preferably about 12.5% of the total height of the fan.

Representative Paragraph 41: The HVAC system of Representative Paragraph 40, wherein each fan blade is arranged upon the upper ring such that there is a consistent spacing between adjacent fan blades around an entire circumference of the fan.

Representative Paragraph 42: The HVAC system of Representative Paragraphs 40 or 41, wherein a height of the fan is within a range of about 40-50% of a diameter of the fan, preferably within a range of about 45 to 49%.

Representative Paragraph 43: The HVAC system of any one of Representative Paragraphs 30-42, further comprising the structure of one or more of Representative Paragraphs 1-29.

Representative Paragraph 44: An HVAC system for a vehicle, comprising:
a ventilation housing comprising an air inlet that is configured to receive air from a discharge of a ventilation fan, the housing comprises an evaporator and a heater that are each within a heat pump system, the ventilation housing further comprises a plurality of doors therewith that are controllable by an HVAC controller to direct air within and out of the ventilation housing, the housing further comprising a panel outlet, a rear outlet, and a front floor outlet;
wherein the air inlet directs the received air to the evaporator, the heater is positioned such that air that leaves the evaporator can flow through the heater or can bypass the heater depending upon the position of a first door,
wherein the first door is positionable in a first position that allows air leaving the evaporator to flow to the heater and prevents air from flowing directly to a rear outlet, and a second position that prevents air leaving the evaporator to flow to the heater and allows to flow into a first plenum and toward the rear outlet;
the plurality of doors further comprises a second door positioned downstream of the heater, wherein when the second door is in a first position air leaving the heater is allowed to flow through a second plenum and toward the rear outlet, and when the second door is in a second position, air leaving the heater is prevented from flowing into the second plenum and toward the rear outlet;
wherein the first and second plenums have substantially the same cross-sectional at smallest portion of each respective plenum, and wherein the first and second plenums each have substantially the same cross-sectional area at their smallest portion as a cross-sectional area of the rear outlet of the ventilation housing.

Representative Paragraph 45: The HVAC system of Representative Paragraph 44, wherein the ventilation housing is left and right ventilation housings, wherein a first portion of air leaving the evaporator enters into the first ventilation housing and a second remaining portion of air leaving the evaporator enters into the second ventilation housing, wherein the first door comprises a right first door and a left first door, wherein the right and left first doors are independently operable by the HVAC controller, and the second door comprises a right second door and a left second door, wherein the right and left second doors are independently operable by the HVAC controller.

Representative Paragraph 46: The HVAC system of Representative Paragraph 45, wherein the first plenum comprises a right first plenum that is within the right ventilation housing and the second plenum comprises a right second plenum that is within the right ventilation housing, and
the first plenum comprises a left first plenum that is within the left ventilation housing and the second plenum comprises a left second plenum that is within the left ventilation housing,
wherein the rear outlet comprises a right rear outlet through which air from the right housing flows and the rear outlet comprises a left rear outlet through which air from the left housing flows,
wherein the right first plenum and the right second plenum have substantially the same cross-sectional area at a smallest portion of each respective plenum, that is substantially the same as a cross-sectional area of the right rear outlet,
wherein the left first plenum and the left second plenum have substantially the same cross-sectional area at a smallest portion of each respective plenum, that is substantially the same as a cross-sectional area of the left rear outlet.

Representative Paragraph 47: The HVAC system of any one of Representative Paragraphs 44-46, wherein the first plenum and the second plenum are about 116 cm2 in cross-sectional area at a smallest portion by cross-sectional area, and rear outlet is about 116 cm2 in cross-sectional area.

Representative Paragraph 48: The HVAC system of any one of Representative Paragraphs 44-47, wherein a cross-sectional area of the rear outlet is between about 90 cm2 and about 115 cm2.

Representative Paragraph 49: The HVAC system of any one of Representative Paragraphs 44-47, further comprising the structure of one of more of Representative Paragraphs 1-43.

Representative Paragraph 50: A HVAC system for a vehicle, comprising:
a distribution housing for receiving conditioned air, the distribution housing including an inlet and a plurality of outlets, the plurality of outlets comprise a first outlet for a second row floor vent, a second outlet for a second row console vent, and a third outlet for a third row vent;
the distribution housing further comprising an inlet section through which all air flowing through the inlet flows, and upper and lower sections that extend from the inlet section, wherein the upper section is vertically above the lower section when the distribution housing is installed within a vehicle, wherein air that flows toward one of the first or second outlets flows into the upper section and air that flows through the third outlet flows into the lower section,
further comprising a first door in the upper section, wherein when the first door is in a first position air flows to the first outlet and is prevented from flowing to the second outlet, and when the first door is in a second position, air is prevented from flowing to the first outlet and air is allowed to flow toward the second outlet, wherein the first door can be positioned in an intermediate position that allows air to flow to the first outlet and to flow toward the second outlet.

Representative Paragraph 51: The HVAC system of Representative Paragraph 50, wherein the distribution housing further comprises a fourth outlet, the fourth outlet extending from the upper section, which allows air to flow to a second row side wall vent within the vehicle, wherein when the first door is in the first position, air is prevented from flowing to the fourth outlet, and when the first door is in the second position, air is allowed to flow to the fourth outlet, and when the first door is in the intermediate position air is allowed to flow to the fourth outlet.

Representative Paragraph 52: The HVAC system of Representative Paragraph 51, further comprising a second door disposed within the upper section and downstream of the first door, wherein air can flow to the second door when the first door is in the second position or the intermediate position, wherein when the second door is in the first position air flows to the fourth outlet and is prevented from flowing to the second outlet, when the second door is in the second position, air flows to the second outlet and is prevented from flowing to the fourth outlet, wherein the second door can be in an intermediate position that allows air to flow to the second outlet and to the fourth outlet.

Representative Paragraph 53: The HVAC system of Representative Paragraph 52, wherein the inlet includes a right inlet and a left inlet that are next to each other and separated by a wall, wherein a cross-sectional area of the right and left inlets are the same,
wherein the upper section includes right and left upper sections that are divided by an upper wall that extends from the wall, a geometry of the right and left upper sections are the same along their lengths;
wherein the lower section includes right and left lower sections that are divided by a lower wall that extends from the wall, a geometry of the right and left lower sections are the same along their length;
wherein the first door includes a right first door that is within the right upper section and the first door includes a left first door that is within the left upper section, wherein the right first door and the left first door are independently controllable and can be in either the same or different positions.

Representative Paragraph 54: The HVAC system of Representative Paragraph 53, wherein the second door includes a right second door that is within the right upper section and the second door includes a left second door that is within the left upper section, wherein the right second door and the left second door are independently controllable and can be in either the same or different positions.

Representative Paragraph 55: The HVAC system of any one of Representative Paragraphs 53 or 54, wherein the first door and the second door are each end pivot doors that are moved with an actuator that provides torque to an end portion of the door, with the door extending from only one side of the end portion of the door.

Representative Paragraph 56: The HVAC system of any one of Representative Paragraphs 53-55, further comprising the structure of one or more of Representative Paragraphs 1-52.

Representative Paragraph 57: A flow selector mechanism for an HVAC system for a vehicle, comprising:
a housing that includes an air inlet and first and second outlets, the air inlet configured to receive conditioned air flowing therein;
a rotatable valve disposed within the housing, the valve can be in positions to block the air inlet, block the first outlet, block the second outlet, and in a position to allow to flow from the air inlet and to the first and second outlets simultaneously,
the housing includes a body, which may be circular or substantially circular or formed with other outer shapes with an internal circular or substantially circular inner profile, the valve rotates about an axis that is the same as the center of the circular body, wherein the valve includes a pivot that extends through or close to the center of the circular body, an outer curved surface, and a radial rib that connects the outer curved surface to the pivot;
wherein the air inlet extends radially from the body, and the first outlet and the second outlet each extending from the body on opposite sides of a line that extends through the center of the body and a centerline through the air inlet.

Representative Paragraph 58: The flow selector mechanism of Representative Paragraph 57, housing includes top and bottom walls and a side wall that extends between the top and bottom walls and along an outer circumference of the housing, wherein the side wall along positions where the air inlet and the first and second air outlets extend from the housing is at a first constant radius from the center, wherein a first portion of the side wall between the air inlet and the first air outlet, and a second portion of the side wall between the air inlet and the second air outlet is at a second radius that is larger than the first radius of the side wall along positions where the air inlet and first and second air outlets extend.

Representative Paragraph 59: The flow selector mechanism of Representative Paragraph 58, wherein the valve includes a curved portion that is disposed just inboard of the side wall, wherein the valve has a longer curved length than a curved length of an opening in the side wall for the air inlet, and longer circumferential length than a circumferential length of first and second openings in the side wall for the respective first and second air outlets.

Representative Paragraph 60: The flow selector mechanism of Representative Paragraph 59, wherein the curved portion of the valve has a constant curve, wherein the radius of the constant curve is slightly less than the first radius of the side wall.

Representative Paragraph 61: The flow selector mechanism of Representative Paragraph 60, wherein the valve includes a compressible layer that extends outward from a surface of the valve that faces radially outward toward the side wall, wherein the compressible layer extends along a left edge portion of the valve, a right edge portion of the valve, a top edge portion of the valve, and a bottom edge portion of the valve, wherein the left and the right edge portions are parallel to the rotational axis of the door, and the top and bottom edge portions are both perpendicular to the rotational axis of the valve,

Representative Paragraph 62: The flow selector mechanism of Representative Paragraph 62, wherein the compressible layer extends away from the valve a distance, such that when the compressible layer is not compressed the outer surface of the compressible layer is greater than the first radius but smaller than the second radius.

Representative Paragraph 63: The flow selector mechanism of Representative Paragraph 63, wherein the valve is arranged such that when the valve is aligned with one of the air inlet, or the first or second air outlets, the compressible layer contacts the side wall of the housing and slightly compresses the compressible layer.

Representative Paragraph 64: The flow selector mechanism of Representative Paragraph 63, wherein when the valve is aligned with one of the air inlet, or the first or second air outlets, the contact with the side wall compresses the compressible layer within a range of about 5% to 25% of an overall thickness of the compressible layer.

Representative Paragraph 65: The flow selector mechanism of Representative Paragraph 61, wherein when the valve is aligned with one of the air inlet or the first or second air outlets, the compressible layer is disposed entirely outboard of the opening in the housing for the respective aligned inlet or first or second outlet, such that the compressible layer contacts the housing and is not aligned with the opening in the housing for the respective aligned inlet or first or second outlet.

Representative Paragraph 66: The flow selector mechanism of any one of Representative Paragraphs 58-65, wherein one or both the top and bottom walls of the housing includes a circular ridge that extends inwardly toward the other of the top or bottom wall, wherein the center of the circular ridge is the center of the circular body, wherein the door includes a foot portion that extends from the radial rib to contact a surface of the circular ridge, with the foot portion maintaining contact with the radial rib as the door is rotated within the housing.

Representative Paragraph 67: The flow selector mechanism of Representative Paragraph 58, further comprising stop disposed within the housing, wherein a first side of the valve contacts the stop when the door is in a first position that is aligned to block the air inlet, and wherein an opposite second side contacts the stop when the valve is aligned in a second position to not block the air inlet, not block the first air outlet, and either not block or not substantially block the second air outlet.

Representative Paragraph 68: The flow selector mechanism of Representative Paragraph 67, wherein the stop is a first boss that extends inwardly from the top wall and a second boss that extends inwardly from the bottom wall, wherein the first and second bosses are aligned with each other.

Representative Paragraph 69: The flow selector mechanism of Representative Paragraph 68, wherein the first and second bosses receive a fastener therethrough to fix the top and bottom walls of the housing together.

Representative Paragraph 70: The flow selector mechanism of Representative Paragraph 67, wherein a first side of the radial rib contacts the stop when the valve is aligned in the first position to block the air inlet, and wherein an opposite side of the radial rib contacts the boss when the valve is aligned in the second position.

Representative Paragraph 71: The flow selector mechanism of Representative Paragraph 70, wherein one or both of the first and second sides of the radial rib includes inward cutouts that are aligned such that the stop is aligned within the respective inward cutout when in the first position or the second position, which increases the possible angular range of motion of the door within the housing.

Representative Paragraph 72: The flow selector mechanism of any one of Representative Paragraphs 57-71, wherein the valve is caused to be rotated by an HVAC controller and the valve includes an operator that controls the rotation of the valve.

Representative Paragraph 73: The flow selector mechanism of any one of Representative Paragraphs 58-72, wherein a width of the air inlet opening in the housing is substantially the same as the first radius of the side wall.

Representative Paragraph 74: The flow selector mechanism of Representative Paragraph 73, wherein a cross-sectional area of each of the first and second air outlets in the side wall is larger than a cross-sectional area of the air inlet side wall.

Representative Paragraph 75: The flow selector mechanism of any one of Representative Paragraphs 57-74, wherein the housing and the door are aligned such that air that enters the housing through the air inlet can flow through the housing and past the radial rib when flowing to one of the first or second outlets.

Representative Paragraph 76: The flow selector mechanism of Representative Paragraph 75, wherein the radial rib is disposed between the top and bottom walls of the housing, wherein air entering the housing through the air inlet can flow either above or below the radial rib in a direction toward one of the first or second air outlets.

Representative Paragraph 77: The flow selector mechanism of any one of Representative Paragraphs 57-76, further comprising the structure of one or more of Representative Paragraphs 1-56.

1. A HVAC system for a vehicle, comprising:
a distribution housing for receiving conditioned air, the distribution housing including an inlet and a plurality of outlets, the plurality of outlets comprise a first outlet for a second row floor vent, a second outlet for a second row console vent, and a third outlet for a third row vent;
the distribution housing further comprising an inlet section through which all air flowing through the inlet flows, and upper and lower sections that extend from the inlet section, wherein the upper section is vertically above the lower section when the distribution housing is installed within a vehicle, wherein air that flows toward one of the first or second outlets flows into the upper section and air that flows through the third outlet flows into the lower section,
further comprising a first door in the upper section, wherein when the first door is in a first position air flows to the first outlet and is prevented from flowing to the second outlet, and when the first door is in a second position, air is prevented from flowing to the first outlet and air is allowed to flow toward the second outlet, wherein the first door can be positioned in an intermediate position that allows air to flow to the first outlet and to flow toward the second outlet.

2. The HVAC system of claim 1, wherein the distribution housing further comprises a fourth outlet, the fourth outlet extending from the upper section, which allows air to flow to a second row side wall vent within the vehicle, wherein when the first door is in the first position, air is prevented from flowing to the fourth outlet, and when the first door is in the second position, air is allowed to flow to the fourth outlet, and when the first door is in the intermediate position air is allowed to flow to the fourth outlet.

3. The HVAC system of claim 2, further comprising a second door disposed within the upper section and downstream of the first door, wherein air can flow to the second door when the first door is in the second position or the intermediate position, wherein when the second door is in the first position air flows to the fourth outlet and is prevented from flowing to the second outlet, when the second door is in the second position, air flows to the second outlet and is prevented from flowing to the fourth outlet, wherein the second door can be in an intermediate position that allows air to flow to the second outlet and to the fourth outlet.

4. The HVAC system of claim 3, wherein the inlet includes a right inlet and a left inlet that are next to each other and separated by a wall, wherein a cross-sectional area of the right and left inlets are the same,
wherein the upper section includes right and left upper sections that are divided by an upper wall that extends from the wall, a geometry of the right and left upper sections are the same along their lengths;
wherein the lower section includes right and left lower sections that are divided by a lower wall that extends from the wall, a geometry of the right and left lower sections are the same along their length;
wherein the first door includes a right first door that is within the right upper section and the first door includes a left first door that is within the left upper section, wherein the right first door and the left first door are independently controllable and can be in either the same or different positions.

5. The HVAC system of claim 4, wherein the second door includes a right second door that is within the right upper section and the second door includes a left second door that is within the left upper section, wherein the right second door and the left second door are independently controllable and can be in either the same or different positions.

6. The HVAC system of claim 4, wherein the first door and the second door are each end pivot doors that are moved with an actuator that provides torque to an end portion of the door, with the door extending from only one side of the end portion of the door.

7. The HVAC system of claim 1, further comprising flow selector mechanism, the flow selector mechanism comprises:
a housing that includes an air inlet that receives air from the third outlet and first and second flow selector outlets, the air inlet configured to receive conditioned air flowing therein;
a rotatable valve disposed within the housing, the valve can be in positions to block the air inlet, block the first flow selector outlet, block the second flow selector outlet, and in a position to allow to flow from the air inlet and to the first and second flow selector outlets simultaneously,
the housing includes a circular body, the rotatable valve rotates about an axis that is the same as the center of the circular body, wherein the rotatable valve includes a pivot that extends through or close to the center of the circular body, an outer curved surface, and a radial rib that connects the outer curved surface to the pivot;
wherein the air inlet extends radially from the circular body, and the first flow selector outlet and the second flow selector outlet each extending from the circular body on opposite sides of a line that extends through the center of the circular body and a centerline through the air inlet.

8. The flow selector mechanism of claim 7, housing includes top and bottom walls and a side wall that extends between the top and bottom walls and along an outer circumference of the housing, wherein the side wall along positions where the air inlet and the first second flow selector outlets extend from the housing is at a first constant radius from the center, wherein a first portion of the side wall between the air inlet and the first flow selector outlet, and a second portion of the side wall between the air inlet and the second flow selector outlet is at a second radius that is larger than the first radius of the side wall along positions where the air inlet and first and second flow selector outlets extend.

9. The flow selector mechanism of claim 8, wherein the rotatable valve includes a curved portion that is disposed just inboard of the side wall, wherein the rotatable valve has a longer curved length than a curved length of an opening in the side wall for the air inlet, and longer circumferential length than a circumferential length of first and second openings in the side wall for the respective first and second flow selector outlets.

10. The flow selector mechanism of claim 9, wherein the rotatable valve includes a compressible layer that extends outward from a surface of the rotatable valve that faces radially outward toward the side wall, wherein the compressible layer extends along a left edge portion of the rotatable valve, a right edge portion of the rotatable valve, a top edge portion of the rotatable valve, and a bottom edge portion of the rotatable valve, wherein the left and the right edge portions are parallel to the rotational axis of the door, and the top and bottom edge portions are both perpendicular to the rotational axis of the rotatable valve.

11. The flow selector mechanism of claim 10, wherein the compressible layer extends away from the rotatable valve a distance, such that when the compressible layer is not compressed the outer surface of the compressible layer is greater than the first radius but smaller than the second radius.

12. The flow selector mechanism of claim 10, wherein the when the rotatable valve is aligned with one of the air inlet or the first or second flow selector outlets, the compressible layer is disposed entirely outboard of the opening in the housing for the respective aligned inlet or first or second flow selector outlet, such that the compressible layer contacts the housing and is not aligned with the opening in the housing for the respective aligned inlet or first or second flow selector outlet.

13. The flow selector mechanism of claim 8, wherein one or both the top and bottom walls of the housing includes a circular ridge that extends inwardly toward the other of the top or bottom wall, wherein the center of the circular ridge is the center of the circular body, wherein the door includes a foot portion that extends from the radial rib to contact a surface of the circular ridge, with the foot portion maintaining contact with the radial rib as the door is rotated within the housing.

14. The flow selector mechanism of claim 28, wherein the rotatable valve is caused to be rotated by an HVAC controller and the rotatable valve includes an operator that controls the rotation of the rotatable valve, wherein the first door is caused to be repositioned by the HVAC controller.
